(19) United States
(12) Patent Application Publication
(10) Pub. No.: US 2015/0094866 A1
(43) Pub. Date: Apr. 2, 2015

(54) BLOWOUT PREVENTER CONTROL AND/OR POWER AND/OR DATA COMMUNICATION SYSTEMS AND RELATED METHODS

(71) Applicant: TRANSOCEAN INNOVATION LABS, LTD, George Town (KY)

(72) Inventors: Luis Pereira, Katy, TX (US); Jose Gutierrez, Houston, TX (US); John Matthew Dalton, Missouri City, TX (US); Guy Robert Babbitt, Fort Collins, CO (US); Terry Dickson, Inverness (GB); Fari Godazandeh, Houston, TX (US); Mete Mutlu, Houston, TX (US); Taofik Wassar, Houston, TX (US)

(21) Appl. No.: 14/499,146

(22) Filed: Sep. 27, 2014

Related U.S. Application Data
(60) Provisional application No. 61/883,623, filed on Sep. 27, 2013.
(60) Provisional application No. 61/883,692, filed on Sep. 27, 2013.
(60) Provisional application No. 61/883,730, filed on Sep. 27, 2013.
(60) Provisional application No. 61/883,786, filed on Sep. 27, 2013.
(60) Provisional application No. 61/883,818, filed on Sep. 27, 2013.
(60) Provisional application No. 61/883,836, filed on Sep. 27, 2013.
(60) Provisional application No. 61/883,868, filed on Sep. 27, 2013.
(60) Provisional application No. 61/885,331, filed on Oct. 1, 2013.

(51) Int. Cl. E21B 33/06; G05B 15/02; H04L 29/08; G05D 7/06

(52) U.S. Cl. CPC E21B 33/06; G05D 7/0635; G05B 15/02; H04L 67/10
USPC 700/282

(57) ABSTRACT

This disclosure includes BOP control and/or power and/or data communication systems and related methods. Some systems use or include a plurality of controllers, each in communication with a BOP control network and configured to transmit information associated with the BOP, and a signal conditioning circuit in electrical communication with and configured to provide a power signal and a data signal to at least one of the plurality of controllers, the signal conditioning circuit including a signal coupler, a subsea signal decoupler, an amplifier, and/or a frequency converter, where each controller is in communication with one or more processors and is configured to transmit at least a portion of the information through the BOP control network during a respective time interval.

### CROSS-REFERENCE TO RELATED APPLICATIONS

This application claims priority to: (1) U.S. Provisional Application No. 61/883,623, filed on Sep. 27, 2013 and entitled “NEXT GENERATION BLOWOUT PREVENTER (BOP) CONTROL OPERATING SYSTEM AND COMMUNICATIONS;” (2) U.S. Provisional Application No. 61/883,692, filed on Sep. 27, 2013 and entitled “COMMUNICATIONS/DATA TRANSFER IN A BLOWOUT PREVENTER (BOP) CONTROL SYSTEM;” (3) U.S. Provisional Application No. 61/883,730, filed on Sep. 27, 2013 and entitled “HIGH FREQUENCY POWER DISTRIBUTION FOR A BLOWOUT PREVENTER (BOP) CONTROL SYSTEM;” (4) U.S. Provisional Application No. 61/883,786, filed on Sep. 27, 2013 and entitled “LOGGING INFORMATION IN A BLOWOUT PREVENTER (BOP) CONTROL OPERATING SYSTEM FOR SIMULATION PLAYBACK;” (5) U.S. Provisional Application No. 61/883,818, filed on Sep. 27, 2013 and entitled “COMBINED POWER AND DATA DISTRIBUTION FOR A BLOWOUT PREVENTER (BOP) CONTROL OPERATING SYSTEM;” (6) U.S. Provisional Application No. 61/883,836, filed on Sep. 27, 2013 and entitled “ADVANCED BLOWOUT PREVENTER (BOP) CONTROLLER IN A BOP CONTROL OPERATING SYSTEM;” (7) U.S. Provisional Application No. 61/883,868, filed on Sep. 27, 2013 and entitled “INCREASED RELIABILITY, AVAILABILITY, AND FAULT TOLERANCE OF A BLOWOUT PREVENTER (BOP);” and (8) U.S. Provisional Application No. 61/885,331, filed on Oct. 1, 2013 and entitled “AUTONOMOUS CONTROL, MONITORING, AND ANALYSIS OF A BLOWOUT PREVENTER (BOP).” Each of the foregoing provisional patent applications is incorporated by reference in its entirety.

### BACKGROUND

1. Field of Invention

The present invention relates generally to blowout preventers, and more specifically, but not by way of limitation, to control and/or power and/or data communication systems for subsea blowout preventers.

2. Description of Related Art

At present, there exists a variety of blowout preventer (BOP) system architectures with varying functionality, some of which may be customized for particular applications. For example, BOP systems may be used on land or subsea (e.g., at depths on the order of meters to depths on the order of kilometers). Thus, variations amongst BOP systems may be numerous.

### SUMMARY

Some embodiments of the present BOP control system comprise a plurality of controllers, each in communication with a BOP control network and configured to transmit information associated with the BOP, and a signal conditioning circuit in electrical communication with and configured to provide a power signal and a data signal to at least one of the plurality of controllers, the signal conditioning circuit comprising a signal coupler configured to receive the power signal and the data signal and couple the power and data signals into a combined power and data signal, a subsea signal decoupler in electrical communication with the signal coupler and configured to receive the combined power and data signal and decouple the power signal and the data signal, an amplifier configured to increase the amplitude of at least one of: the power signal, the data signal, and the combined power and data signal, where each controller is in communication with one or more processors and is configured to transmit at least a portion of the information through the BOP control network during a respective time interval, and where the signal conditioning circuit forms at least a portion of the BOP control network.

Some embodiments of the present BOP control systems comprise a plurality of controllers, each in communication with a BOP control network and configured to transmit information associated with the BOP, where each controller is in communication with one or more processors and is configured to transmit at least a portion of the information through the BOP control network during a respective time interval.

In some embodiments, the system is configured such that each controller can only transmit the at least a portion of the information through the BOP control network during the respective time interval assigned to the controller. In some embodiments, the system is configured to detect an absence of information transmitted through the BOP control network from a controller during the respective time interval assigned to the controller.

In some embodiments, at least two controllers are configured to control or monitor a same function on the BOP. In some embodiments, the at least two controllers are assigned overlapping time intervals.

In some embodiments, at least one controller is configured to at least one of control, monitor, and analyze a BOP component. In some embodiments, at least one controller comprises at least one memory configured to store at least a portion of the information associated with the BOP. In some embodiments, at least one controller comprises an operating system. In some embodiments, at least one controller comprises a BOP control application. In some embodiments, at least one controller comprises one or more sensors configured to capture at least a portion of the information associated with the BOP. In some embodiments, at least one controller comprises components located in at least one of a subsea location, an offshore and above-sea location, and an onshore location.

Some embodiments comprise a simulating controller configured to receive the at least a portion of the information stored in the memory, and simulate, based at least in part on the at least a portion of the information, operation of a BOP component. Some embodiments comprise a simulating controller configured to receive at least a portion of the information transmitted by the plurality of controllers via the BOP control network and simulate, based at least in part on the at least a portion of the information, operation of a BOP component. In some embodiments, the simulating controller is configured to output a visual representation of the simulated operation of the BOP component.

In some embodiments, at least one of the one or more processors comprises at least one of a subsea processor, an offshore and above-sea processor, and an onshore processor. In some embodiments, at least one controller is in communication with at least two processors.

In some embodiments, the BOP control network comprises a plurality of subnetworks. In some embodiments, at least one subnetwork comprises a subsea subnetwork, an offshore and above-sea subnetwork, and an onshore network. In some embodiments, the BOP control network comprises one or more bridges, each in direct communication with at least two subnetworks. In some embodiments, at least one bridge comprises a subsea bridge. In some embodiments, at least one bridge comprises a satellite bridge.

Some embodiments comprise a human-machine interface (HMI) in communication with the BOP control network. Some embodiments comprise a memory configured to store at least a portion of the information transmitted by the plurality of controllers via the BOP control network.

Some embodiments of the present methods for controlling a BOP comprise identifying a plurality of controllers, each in communication with a BOP control network and configured to transmit information associated with the BOP, placing each controller into communication with one or more processors, assigning to each controller a respective time interval during which the controller can transmit information through the BOP control network, providing a power signal and a data signal to at least one of the plurality of controllers by coupling a power signal and a data signal to create a combined power and data signal, decoupling, subsea, the combined power and data signal into the power signal and the data signal, increasing the frequency and the amplitude of at least one of the power signal, the data signal, and the combined power and data signal, and transmitting the power signal and the data signal to the at least one of the plurality of controllers, monitoring the BOP control network during each respective time interval for a transmission of information associated with the controller assigned the respective time interval, transmitting through the BOP control network, with a first controller, and during the respective time interval assigned to the first controller, an identifier associated with a first subsea component of the BOP in communication with the first controller, identifying one or more controllable functions of the first subsea component based at least in part on the identifier, and actuating at least one of the one or more controllable functions of the first subsea component.

Some embodiments of the present methods for controlling a BOP comprise identifying a plurality of controllers, each in communication with a BOP control network and configured to transmit information associated with the BOP, placing each controller into communication with one or more processors, assigning to each controller a respective time interval during which the controller can transmit information through the BOP control network, and transmitting through the BOP control network, with a first controller, and during the respective time interval assigned to the first controller, information associated with the first controller. In some embodiments, the identifying the plurality of controllers comprises scanning a BOP control network to locate controllers in communication with the BOP control network. In some embodiments, the transmitting occurs through a plurality of replicate channels of the BOP control network.

In some embodiments, the respective time intervals are assigned to each controller such that no time interval respective to any one of the controllers in communication with a first set of one or more BOP components overlaps any other time interval respective to any one of the controllers in communication with a second set of one or more BOP components, the first set of BOP components different than the second set of BOP components. In some embodiments, the respective time interval for each controller reoccurs periodically. In some embodiments, the transmitting with the first controller only occurs during the respective time interval assigned to the first controller. Some embodiments comprise monitoring the BOP control network during each respective time interval for a transmission of information associated with the controller assigned the respective time interval.

Some embodiments comprise storing in a memory associated with the first controller, at least a portion of the information associated with the first controller. Some embodiments comprise accessing via the BOP control network, with a second controller, and upon authorization, at least a portion of the information associated with the first controller stored in the memory. Some embodiments comprise accessing via the BOP control network, with a second controller, and upon authorization, at least a portion of the information associated with the first controller transmitted via the BOP control network.

In some embodiments, providing authorization to the second controller comprises receiving a request from the second controller to access the at least a portion of the information associated with the first controller and determining whether the second controller is authorized to access the at least a portion of the information associated with the first controller. In some embodiments, determining whether the second controller is authorized to access the at least a portion of the information associated with the first controller comprises determining whether a user name associated with the second controller is present in a list of authorized user names. In some embodiments, accessing with the second controller occurs during the respective time interval assigned to the first controller.

Some embodiments comprise receiving information associated with at least one controller, and simulating, based at least in part on the received information, operation of a BOP component. In some embodiments, the simulating is performed substantially simultaneously with an actual operation of the BOP component. In some embodiments, the information is received by reading information transmitted through the BOP control network. In some embodiments, the information is received by reading from a memory configured to store information transmitted through the BOP control network. Some embodiments comprise displaying a visual representation of the simulation on a human-machine interface (HMI).

Some embodiments comprise adding an additional controller to the plurality of controllers, placing the additional controller into communication with one or more processors, and assigning to the additional controller a respective time interval during which the controller can transmit information through the BOP control network.

Some embodiments of the present methods for controlling a BOP comprise identifying a plurality of controllers, each in communication with a BOP control network and configured to transmit information associated with the BOP, placing each controller into communication with one or more processors, assigning to each controller a respective time interval during which the controller can transmit information through the BOP control network, and monitoring the BOP control network during each respective time interval for a transmission of information associated with the controller assigned the respective time interval.

Some embodiments comprise detecting a malfunction in a transmission of information associated with at least one controller during the respective time interval assigned to the at least one controller. Some embodiments comprise detecting an absence of a transmission of information associated with at least one controller during the respective time interval assigned to the at least one controller. Some embodiments comprise activating an emergency BOP control process.

Some embodiments of the present methods for controlling one or more functions of a BOP comprise receiving a first identifier associated with a first BOP component, identifying, based at least in part on the first identifier, a first BOP component model containing data indicative of the structure and one or more controllable functions of the first BOP component, and actuating at least one of the one or more controllable functions of the first BOP component, based at least in part on the data contained in the first BOP component model. In some embodiments, the identifying comprises searching a component model database for a BOP component model having an identifier the same as the first identifier. In some embodiments, the first BOP component comprises a BOP.

Some embodiments comprise outputting a visual representation of the first BOP component model at a user interface, receiving a control input at the user interface, and actuating at least one of the one or more controllable functions of the first BOP component, based at least in part on the control input. Some embodiments comprise updating the visual representation of the first BOP component model to reflect the actuation of the at least one of the one or more controllable functions of the first BOP component.

Some embodiments comprise receiving a second identifier associated with a second component, identifying, based at least in part on the second identifier, a second component model containing data indicative of the structure and one or more controllable functions of the second component, and actuating at least one of the one or more controllable functions of the second component, based at least in part on the data contained in the second component model. In some embodiments, the second component model comprises a BOP.

Some embodiments of the present methods for controlling one or more functions of a BOP comprise placing a controller in communication with a subsea component, receiving from the controller and via a BOP control network in communication with the controller, an identifier associated with the subsea component, and identifying, based at least in part on the identifier, one or more controllable functions of the subsea component. In some embodiments, the identifying comprises identifying, based at least in part on the identifier, a component model containing data indicative of the structure and one or more controllable functions of the subsea component. In some embodiments, the subsea component comprises a blowout preventer.

Some embodiments comprise receiving from the controller and via the BOP control network, information associated with an operation of at least one of the one or more controllable functions of the subsea component, and controlling, based at least on the information associated with the operation of the at least one of the one or more controllable functions of the subsea component, the at least one of the one or more controllable functions of the subsea component.

Some embodiments of the present BOP control systems comprise an amplifier configured to increase the amplitude of at least one of: a power signal, a data signal, and a combined power and data signal, and a frequency converter configured to increase the frequency of at least one of: the power signal, the data signal, and the combined power and data signal, where the system is configured to provide at least one of power and data to one or more subsea controllers.

Some embodiments comprise a signal coupler configured to receive the power signal and the data signal and couple the power signal and the data signal into the combined power and data signal, and a subsea signal decoupler in electrical communication via one or more cables with the signal coupler and configured to receive the combined power and data signal and decouple the power signal and the data signal.

Some embodiments of the present BOP control systems comprise a signal coupler configured to receive a power signal and a data signal and couple the power signal and the data signal into a combined power and data signal, and a subsea signal decoupler in electrical communication via one or more cables with the signal coupler and configured to receive the combined power and data signal and decouple the power signal and the data signal, where the system is configured to provide at least one of power and data to one or more subsea controllers.

Some embodiments comprise an amplifier configured to increase the amplitude of at least one of: the power signal, the data signal, and the combined power and data signal. Some embodiments comprise a frequency converter configured to increase the frequency of at least one of: the power signal, the data signal, and the combined power and data signal.

In some embodiments, the one or more cables comprises a plurality of cables disposed in parallel between the signal coupler and the subsea signal decoupler. In some embodiments, at least one of the one or more cables is inductively coupled to the subsea signal decoupler.

Some embodiments comprise one or more subsea controllers, each in electrical communication with the subsea signal decoupler and configured to receive at least a portion of the power signal and at least a portion of the data signal. In some embodiments, at least two of the subsea controllers are disposed in parallel. In some embodiments, at least two of the subsea controllers are disposed in series.

In some embodiments, the signal coupler is configured to inductively couple the power signal and the data signal into the combined power and data signal. In some embodiments the signal decoupler is configured to inductively decouple the power signal and the data signal.

Some embodiments comprise a subsea rectifier configured to produce a direct current (DC) signal from at least one of: the power signal, the data signal, and the combined power and data signal.

Some of the present methods for providing high frequency power to a subsea BOP control system comprise providing an alternating current (AC) power signal, increasing the frequency and the amplitude of the AC power signal to create a high power AC power signal, and transmitting the high power AC power signal to the subsea BOP control system. In some embodiments, at least one of the AC power signal and the high power AC power signal is coupled with a data signal.

In some embodiments, increasing the frequency and the amplitude of the AC power signal is performed offshore and above-sea. In some embodiments, transmitting the high power AC signal to the subsea BOP control system is performed via two or more electrically parallel cables.

Some embodiments comprise rectifying the high power AC power signal to create a DC power signal, and distributing the DC power signal to one or more components of the subsea BOP control system. In some embodiments, rectifying the high power AC power signal is performed by a subsea rectifier.

Some embodiments of the present methods for distributing power and data to a subsea BOP control system comprise coupling a power signal and data signal to create a combined power and data signal, and transmitting the combined power and data signal to the subsea BOP control system.

In some embodiments, coupling the power signal and the data signal is performed via inductive coupling. In some embodiments, coupling the power signal and the data signal is performed offshore and above-sea.

Some embodiments comprise decoupling the power signal and the data signal from the combined power and data signal. In some embodiments, decoupling the power signal and the data signal is performed via inductive decoupling. In some embodiments, decoupling the power signal and the data signal is performed subsea.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of what is specified, where the percentage includes 0.1, 1, 5, and 10 percent.

Further, a device or system (or a component of either) that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus or system that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a diagram of one embodiment of the present BOP control systems.

FIG. 2 is a flow chart of one embodiment of the present methods for storing information.

FIGS. 3A-3C, and 4 are flow charts of various embodiments of the present methods for controlling, monitoring, and/or analyzing one or more BOP components and/or systems.

FIGS. 5 and 6 are diagrams of various embodiments of file access architectures suitable for use in some embodiments of the present BOP control systems.

FIGS. 7A and 7B are flow charts of various embodiments of the present methods for controlling, monitoring, and/or analyzing one or more BOP components and/or systems.

FIG. 8 is a flow chart of one embodiment of the present methods for accessing information.

FIG. 9 is a flow chart of one embodiment of the present methods for controlling, monitoring, and/or analyzing one or more BOP components and/or systems.

FIG. 10 is a diagram of one embodiment of the present BOP power and/or data communication systems.

FIG. 11 is a diagram of one embodiment of the present BOP power and/or data communication systems.

### DETAILED DESCRIPTION OF ILLUSTRATIVE EMBODIMENTS

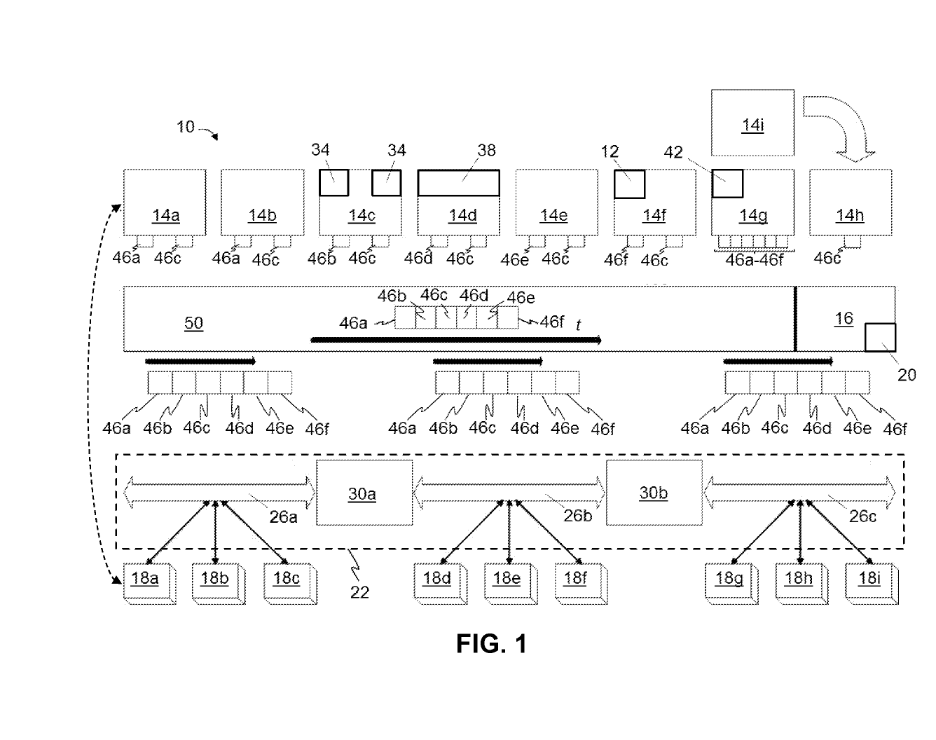

Referring now to the drawings, and more particularly to FIG. 1, shown therein and designated by the reference numeral 10 is one embodiment of the present BOP control systems. In the embodiment shown, BOP control system 10 comprises a plurality of controllers 14a-14h (sometimes referred to collectively as “controllers 14”). Controllers of the present disclosure may comprise processor-executable software (e.g., application(s)), hardware (e.g., processor(s), memories, sensor(s), and/or the like), and/or the like, and are generally configured to monitor, control, and/or analyze a BOP component and/or system, as described in more detail below. BOP components include, but are not limited to, BOP stacks, BOPs and/or components thereof, such as, for example, rams, annulars, accumulators, test valves, failsafe valves, kill and/or choke lines and/or valves, riser joints, hydraulic connectors, and/or the like. A BOP system includes, but is not limited to, BOP components, low marine riser packages (LMRPs), risers, auxiliary cables, rigid conduits, pumps and/or hydraulic power units (e.g., whether above-sea and/or subsea), control stations (e.g., whether on a drilling rig, onshore, and/or the like), and/or the like.

In the embodiment shown, BOP control system 10 comprises one or more memories. Memories of the present BOP control systems can be in communication with any suitable component (e.g., controller(s), processor(s), operating system(s), BOP control network(s), virtual BOP control network(s), and/or the like), and may be physically disposed subsea, above-sea and offshore, and/or onshore. For example, in the depicted embodiment, at least one of controllers 14 (e.g., 14f) (e.g., up to and including all of controllers 14) comprises a memory (e.g., 12). In some embodiments, a memory can be configured to store processor-executable software of a controller 14. For example, in some embodiments, a controller 14 comprising a memory can be implemented by a processor 18 by placing the memory into communication with the processor (e.g., and executing the processor-executable software of the controller with the processor). In the embodiment shown, a system memory 20 can be in communication with BOP control network 22, virtual BOP control network 50, an operating system 16, and/or the like. In some embodiments, controllers 14 may be selectively assigned, or placed in communication with, one or more memories, similarly to as described below for processors 18.

One or more of controllers 14 (e.g., or portions thereof) may be physically coupled to a monitored, controlled, and/or analyzed component and/or system, whether that component and/or system is disposed subsea, such as, for example, on a hydraulically actuated device of a BOP, above-sea, such as, for example, on a hydraulic power unit disposed on an offshore drilling rig, and/or the like. For example, a sensing controller 14c may be coupled to a hydraulically actuated device of a BOP (e.g., to monitor the hydraulically actuated device, for example, by capturing data indicative of hydraulic fluid temperature, pressure, flow rate, and/or the like within and/or around the hydraulically actuated device with one or more sensors 34).

However, one or more controllers 14 may not be physically coupled to a monitored, controlled, and/or analyzed BOP component and/or system. For example, in some embodiments, one or more controllers (e.g., or portions thereof) (e.g., comprising processor-executable software and/or hardware) may be physically remote from, but in communication with, the monitored, controlled, and/or analyzed BOP component and/or system. For example, a simulating controller 14b may be in communication with a BOP component and/or system (or associated controllers 14 thereof) via BOP control network 22, yet not be physically coupled to the BOP component and/or system. Therefore, controllers 14 of the present BOP control systems may be located subsea, offshore and above-sea, onshore, and/or the like.

In the embodiment shown, each controller is in communication with one or more processors 18a-18i (sometimes referred to collectively as “processors 18”). Processors 18 of the present BOP control systems may be located subsea, offshore and above-sea, onshore, and/or the like. In the embodiment shown, one or more processors 18 are placed into communication with a controller to facilitate functions of the controller, sometimes referred to as “implementing” a controller. Such functions can include, but are not limited to, the execution of processor-executable software, communication of information, implementation of hardware controllers, and/or the like. In other words, one or more processors 18 are configured to provide processing resources to one or more controllers 14. Such communication can be accomplished in any suitable fashion. For example, a controller 14 may be physically coupled into communication with and/or comprise one or more processors 18, and/or may be placed into communication with one or more processors, for example, via electrical and/or network wiring and/or cabling. In some embodiments, it may be desirable that components of a controller 14 (e.g., memories, sensor(s), display(s), and/or the like) be placed in physically close proximity to the processor(s) 18 which implement the controller (e.g., to reduce communication time between the processor(s) and the controller).

By way of example, in this embodiment, processors 18a-18c may be located subsea (e.g., coupled to a BOP) and may be in communication with, for example, sensing controller 14c, which may comprise components located subsea (e.g., sensors 34). By way of further example, in this embodiment, processors 18d-18f may be located offshore and above-sea (e.g., disposed on a drilling rig) and may be in communication with, for example, simulating controller 14b, which may comprise components located offshore and above-sea (e.g., a memory). For yet further example, processors 18g-18i may be located onshore and above-sea (e.g., disposed within an onshore control station) and may be in communication with, for example, a data logging controller 14d, which may be located onshore and above-sea.

In the embodiment shown, one or more processors 18 may be in selective communication with one or more controllers 14. For example, a controller 14 can be selectively assigned, or placed in communication with, a processor 18, for example, via switchable control circuitry, a network (e.g., by associating an address of the controller with an address of the processor), and/or the like (e.g., and such selective assignment may be controlled by a controller 14, an operating system 16, a virtual BOP control network 50, and/or the like). In this way, processing resources (e.g., processors 18) can be distributed and/or redistributed amongst controllers 14 (e.g., depending on the processing power requirements of a controller 14, which may vary over time). Such processor distribution and/or redistribution, in some embodiments, may be facilitated by an asset utilization estimating controller (e.g., 14h) that can be configured to distribute processor(s) 18 amongst controllers 14, for example, to enhance speed, reliability, availability, fault tolerance, and/or the like of the present BOP control systems, controllers, BOP control networks, subnetworks, and/or the like.

In part due to the distributed nature of processor(s) 18 and flexibility of BOP control system 10, any suitable number of controller(s) 14 may be in communication with any suitable number of processor(s) 18 at any given time, regardless of the locations of the processor(s) or controller(s). In this way, the present BOP control systems may achieve increases in speed, reliability, availability, fault tolerance, and/or the like. To illustrate, in some embodiments, a controller 14 may be in communication with more than one processor 18. For example, in the depicted embodiment, simulating controller 14b may be in communication with processors 18d-18f, sensing controller 14c may be in communication with processors 18a-18c, and data logging controller 14d may be in communication with processors 18g-18i.

For controllers 14 in communication with more than one processor 18, processing tasks (e.g., execution of processor-executable software, communication of information, implementation of hardware controllers) can be shared between and/or split amongst multiple processors (e.g., parallel processing, which may enhance processing speed) and/or performed simultaneously by multiple processors (e.g., redundant processing, which may enhance reliability, availability, and/or fault tolerance). For example, if two or more processors 18 are in communication with sensing controller 14c, at least two of the processors may simultaneously communicate data captured by sensors 34 such that one processor fails, at least one other processor may be operable to communicate the data captured by the sensors.

In the embodiment shown, a controller 14 may be in communication with two or more processors 18, where at least two of the processors are physically remote from one another (e.g., at least two of the processors in communication with separate subnetworks 26, described in more detail below) (e.g., to enhance reliability, availability, and/or fault tolerance). For example, data logging controller 14d may be in communication with an onshore processor (e.g., 18g, 18h, 18i, and/or the like), as well as with an above-sea and offshore processor (e.g., 18d, 18e, 18f, and/or the like) such that should an event occur where one or more above-sea and offshore processors and/or subnetwork 26b fails and/or becomes unavailable (e.g., due to an oil drilling accident), the onshore processors may be operable to execute the functions of data logging controller 14d.

In the embodiment shown, communication between and/or amongst controllers 14 and/or processors 18 can be facilitated by BOP control network 22. Networks of the present BOP control systems (e.g., including any subnetworks) can comprise any suitable network, whether wired (e.g., fiber optic), wireless (e.g., Wi-Fi), and/or the like, using any suitable network communication protocol (e.g., Ethernet, TCP/IP, and/or the like), and may be configured to transmit power signals, data signals, and/or combined power and/or data signals (e.g., and may comprise any and/or all of the components of communication system 1000a, described below, such as, for example, amplifier 1020, frequency converter 1024, signal conditioning circuit 1028, signal coupler 1032, signal decoupler 1036, cables 1040, rectifier 1044, and/or the like). The following description of BOP control network 22 is provided only by way of example.

In the embodiment shown, BOP control network 22 comprises one or more subnetworks (e.g., 26a, 26b, 26c, and/or the like), sometimes referred to collectively as “subnetworks 26.” For example, in this embodiment, each of processors 18a-18c may be in communication with BOP control network 22 via subnetwork 26a, processors 18d-18f may be in communication with the BOP control network via subnetwork 26b, and processors 18g-18i may be in communication with the BOP control network via subnetwork 26c. Generally, a controller 14 is in communication with the same subnetwork(s) 26 as processor(s) 18 which implement the controller. A subnetwork may comprise components (e.g., wireless transceivers, hubs, switches, routers, and/or the like) that are subsea, above-sea and offshore, and/or onshore.

In the depicted embodiment, BOP control network 22 comprises one or more bridges (e.g., 30a, 30b, 30c, and/or the like), sometimes referred to collectively as “bridges 30.” In this embodiment, each bridge 30 is in direct communication with (e.g., bridges) at least two subnetworks 26. In this way, each bridge can facilitate communication between at least two subnetworks 26 within BOP control network 22. For example, in the embodiment shown, bridge 30a bridges subnetwork 26a and subnetwork 26b, and bridge 30b bridges subnetwork 26b and subnetwork 26c.

Bridges of the present BOP control systems can comprise any suitable bridges, such as, for example, wired bridges, wireless bridges, satellite bridges, internet bridges, and/or the like, and can be located subsea, above-sea and offshore, and/or onshore. For example, in this embodiment, bridge 30a may, at least in part, be disposed on a drilling riser. By way of further example, the depicted embodiment, bridge 30b comprises a satellite bridge (e.g., a very small aperture terminal (VSAT) network, and/or the like). In embodiments with WAN BOP control networks 22 and/or subnetworks 26, satellite bridges, and/or the like, one or more processors 18 and/or one or more controllers 14 can be located at any suitable location (e.g., globally), yet still in communication with BOP control network 22.

As described above, processors 18 are each in communication with BOP control network 22 (e.g., whether or not via a subnetwork 26), and each controller 14 is in communication with one or more processors 18. Thus, communication between and/or amongst processors 18, controllers 14, other components in communication with BOP control network 22 (e.g., operating system 16, virtual BOP control network 50, and/or the like) may occur through BOP control network 22.

For example, in this embodiment, sensing controller 14c may be in communication with processors 18a and 18h, and simulating controller 14b may be in communication with processor 18c and 18e. In this example, at least in part because processor 18a and 18c are each in communication with subnetwork 26a, sensing controller 14c can communicate with simulating controller 14b via subnetwork 26a. By way of further example, in the depicted embodiment, data logging controller 14d may be in communication with processors 18d and 18a, and interfacing controller 14g may be in communication with processors 18e and 18g. In this example, at least in part because processor 18d and 18e are each in communication with subnetwork 26b, data logging controller 14d can communicate with interfacing controller 14g via subnetwork 26b.

However, controllers 14 are not limited in communication by the subnetworks of the processor(s) 18 which implement them. For example, at least in part due to BOP control network 22 (e.g., subnetworks 26 bridged by bridges 30), controllers 14 can communicate regardless of the subnetwork(s) in which their implementing processor(s) are located. For example, in the embodiment shown, interfacing controller 14g may be in communication with processor 18g, and sensing controller 14c may be in communication with processor 18a. In this example, at least in part because processor 18g is in communication with subnetwork 26c, and processor 18a is in communication with subnetwork 26a, and subnetworks 26a and 26c are in communication with each other (e.g., via bridges 30a and 30b, for example, through subnetwork 26b), interfacing controller 14g can communicate with sensing controller 14c.

In some embodiments, BOP control network 22 comprises a plurality of replicate channels (e.g., redundant network hardware, such as, for example, two or more parallel wireless transceivers, communication cables, subnetworks 26, bridges 30, and/or the like). In these embodiments, one or more controllers 14 (e.g., processor(s) 18 implementing the one or more controllers 14) can be configured to transmit information through the BOP control network 22 through the replicate channels (e.g., whether selectively and/or simultaneously). In this way, reliability, availability, and/or fault tolerance of BOP control network 22 can be increased. For example, in the event that one of two or more replicate channels fails and/or otherwise becomes inoperable to transmit information, at least one other channel may be operable to transmit the information.

As discussed above, controllers 14 of the present BOP control systems may be configured to perform a variety of functions associated with control, monitoring, analysis, and/or the like of a BOP component and/or system. In some embodiments, at least two controllers 14 can each be configured to control, monitor, or analyze a same BOP component and/or system (e.g., each performing the same or similar functions). In this way, should one of the at least two controllers fail, another of the controllers can control, monitor, and/or analyze the BOP component and/or system. The illustrative controllers 14 described below are provided only by way of example, and not by way of limitation. Numerous other controllers, while not explicitly described herein, may be suitable for use within one or more embodiments of the present BOP control systems and do not depart from this disclosure in spirit or scope.

In this embodiment, at least one controller 14 may comprise one or more sensors 34 configured to capture information associated with the BOP (e.g. sensing controller 14c) (e.g., configured to monitor a BOP). Sensors of the present control systems can comprise any suitable sensor, such as, for example, temperature sensors (thermocouples, resistance temperature detectors (RTDs), and/or the like), pressure sensors (e.g., piezoelectric pressure sensors, strain gauges, and/or the like), position sensors (e.g., Hall effect sensors, linear variable differential transformers, potentiometers, and/or the like), velocity sensors (e.g., observation-based sensors, accelerometer-based sensors, and/or the like), acceleration sensors, flow sensors, and/or the like, whether virtual (e.g., processing, for example with a processor 18, information captured by one or more sensors 34 to calculate and/or estimate one or more parameters of interest) and/or physical. Information captured by sensors 34 can be environmental (e.g., hydrostatic pressure of a subsea environment) and/or operational (e.g., hydraulic fluid pressure, flow rate, temperature, and/or the like within a BOP component and/or system).

Controllers 14 of the present BOP control systems can be configured to intercommunicate (e.g., to provide enhanced control, monitoring, and/or analysis of a BOP component and/or system). For example, in this embodiment, a sensing controller (e.g., 14c) can be configured to record (e.g., to a memory, whether of the sensing controller, of the system, such as system memory 20, and/or the like) and/or transmit (e.g., through BOP control network 22) information associated with a BOP component and/or system, and a simulating controller (e.g., 14b) can read the information recorded and/or receive the information transmitted by the sensing controller (e.g., to simulate the operation of the BOP component and/or system, based at least in part on the information).

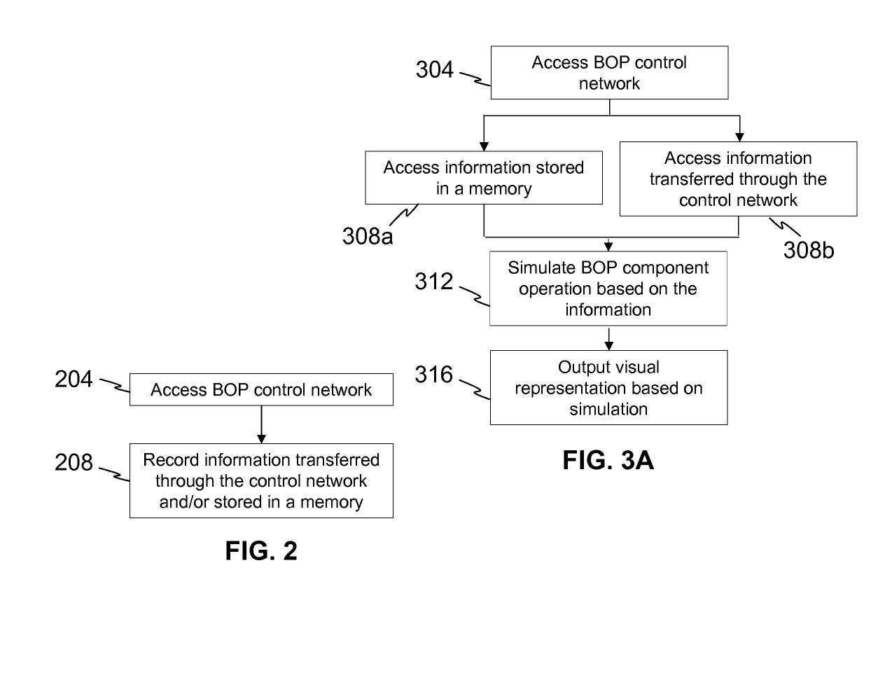

In this embodiment, at least one controller comprises a memory 38 configured to store information associated with a BOP component and/or system (e.g., data logging controller 14d) (e.g., configured to store information for analysis of a BOP component and/or system) (e.g., a block box recorder). For example, and referring additionally to FIG. 2, shown is a flow chart of one embodiment of the present methods for storing information. While the following example is described with reference to data logging controller 14d, the same or similar steps could be performed by any suitable controller 14. The following example can be used to record any suitable information, including, but not limited to, states, events, event/state triggers, actions, performance characteristics, metadata and/or the like related to a BOP component and/or system, function(s) thereof, a BOP control system (e.g., 10), components thereof (e.g., controllers 14, processors 18, and/or the like), and/or the like. In the embodiment shown, at step 204, a controller (e.g., 14d) may access a BOP control network (e.g., 22) on which information is transferred (e.g., by controllers 14) and/or otherwise available (e.g., stored in a memory). In this embodiment, at step 208, such information may be recorded in a memory (e.g., 38), whether the information was transferred through the BOP control network (e.g., by a controller 14) and/or stored in a memory of a controller (e.g., 12) and/or of BOP control system (e.g., memory 20 of BOP control system 10).

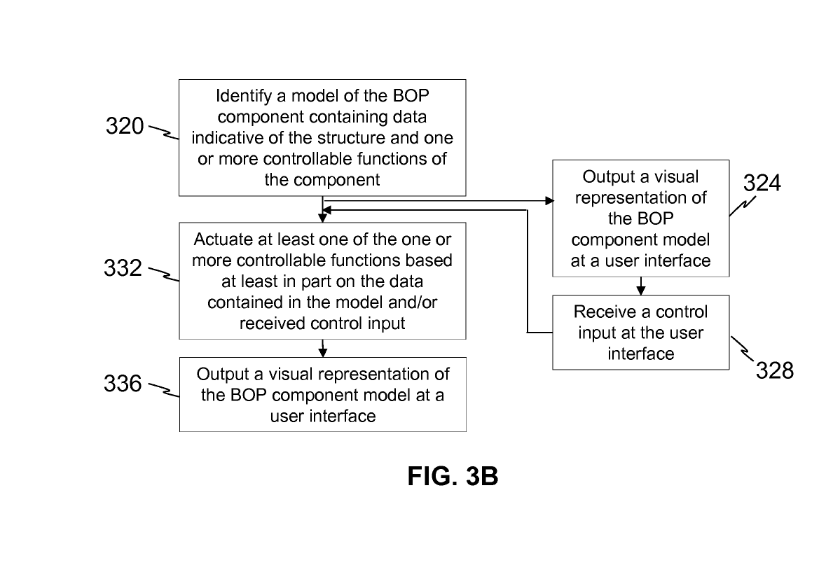

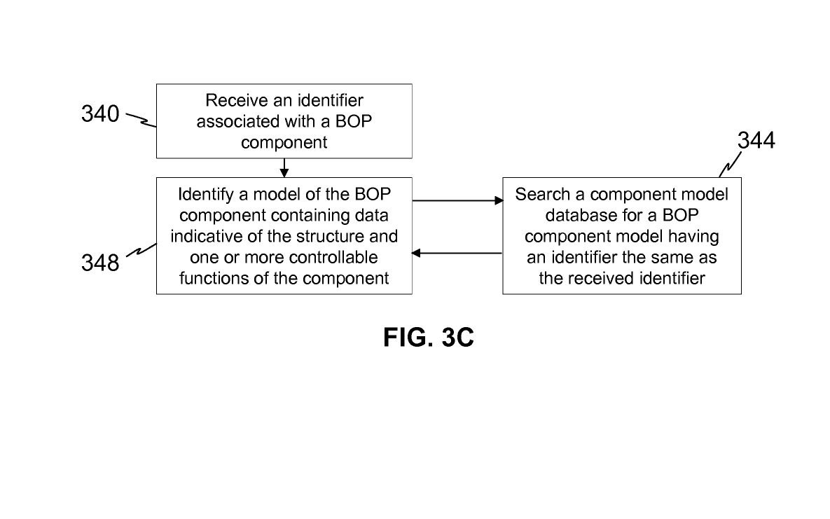

In the depicted embodiment, at least one controller 14 comprises processor-executable software for performing a simulation of a BOP component and/or system (e.g., simulating controller 14b) (e.g., configured to control, monitor, and/or analyze a BOP component and/or system). For example, and referring additionally to FIGS. 3A-3C, shown is a flow chart of various embodiments of the present methods for simulating and/or controlling one or more BOP components and/or systems. In the embodiment shown, at step 304, a controller (e.g., 14b) may access a BOP control network (e.g., 22). In this embodiment, the controller may access information stored in a memory (e.g., of a controller, such as memory 12, and/or of a BOP control system, such as memory 20) (e.g., step 308a), and/or information transferred through the BOP control system (e.g., step 308b). In the depicted embodiment, at step 312, the controller may simulate a BOP component and/or system based at least in part on the information. In the embodiment shown, at step 316, a visual representation of the simulation may be output (e.g., to an interfacing controller 14g, described in more detail below).

While the embodiment shown can be used to simulate and/or control any suitable BOP component and/or system, the following description of a simulation of a valve is provided for merely illustrative purposes. For example, in one embodiment, a sensing controller (e.g., 14c) may detect state information (e.g., open, closed, malfunctioning, and/or the like) associated with a valve through use of a sensor (e.g., 34, such as a position sensor). In this example, the sensing controller may store the state information in a memory (e.g., 12, 20, 38, and/or the like), and/or transmit the information through a BOP control network (e.g., 22). A simulating controller (e.g., 14b) may, in this example, access the BOP control network (e.g., step 304) and access the information (e.g., whether stored in a memory, step 308a, and/or transmitted through the BOP control network, step 308b). In this example, the simulating controller may, based at least in part on the information, simulate the operation of the valve (e.g., at step 312 by adjusting the state of a valve model (e.g., a state machine model) to correspond to the information, for example, open, closed, or malfunctioning).

Simulations of the present BOP control systems may be performed substantially simultaneously with an actual operation of the BOP component. For example, in some embodiments, a command (e.g., entered by a user at a interfacing controller 14g), information transmitted and/or stored by a sensing controller (e.g., 14c), and/or the like, may cause a simulating controller (e.g., 14b) to perform a simulation in a same and/or similar fashion as to described above. In some embodiments, a simulating controller (e.g., 14b) may be configured to periodically perform and/or update such a simulation. In this way, a BOP component and/or system simulation can be performed and/or observed (e.g., at an interfacing controller 14g) in substantially real time.

In some embodiments, a simulation (e.g., performed in a same and/or similar fashion as to described above) can be performed based on an event that occurred previously (e.g., based on information stored in a memory, such as, for example 12, 20, 38, and/or the like) (e.g., to perform an analysis of a BOP component and/or system based on historical data).

As shown FIG. 3B, in some embodiments, a simulating controller (e.g., 14b) may identify a model of a BOP component and/or system. For example, in the embodiment shown, at step 320, a controller (e.g.,14b) may identify a model of the BOP component and/or system containing data indicative of the structure and/or one or more controllable functions of the BOP component and/or system. Models of the present BOP control systems can comprise any suitable model, such as, for example, state machine (e.g., comprising BOP component and/or system states and/or triggering events), physical (e.g., comprising information for modelling functions and/or results of functions for a BOP component and/or system), behavioral (e.g., comprising equations of physics that describe the operation of a BOP component and/or system), and/or the like, and may be stored in a memory (e.g., as processor-executable software). In some embodiments, such models may be and/or be stored in controllers (e.g., 14).

As shown in FIG. 3C, in some embodiments, a model of a BOP component and/or system may be identified by receiving an identifier associated with a BOP component and/or system. For example, in the embodiment shown, at step 340, an identifier associated with a BOP component can be received. By way of illustration, a controller (e.g., 14) in communication with the BOP component and/or system can transmit via a BOP control network (e.g., 22) and/or store in a memory (e.g., 12, 20, 38, and/or the like) the identifier (e.g., as part of a service discovery protocol), and a simulating controller (e.g., 14b) can receive and/or read the identifier. In this embodiment, at step 348, a model of the BOP component and/or system containing data indicative of the structure and one or more controllable functions of the BOP component and/or system can be identified, based at least in part on the received identifier. For example, in the depicted embodiment, at step 344, a component model database (e.g., contained in a memory, such as, for example, 12, 20, 38, and/or the like, located on the internet, and/or the like) can be searched for a BOP component and/or system model having an identifier the same as the received identifier. In at least this way, some controllers of the present BOP control systems can be configured to detect a configuration of a BOP and/or component and automatically configure to perform a function according to the detected configuration.

Referring back to FIG. 3B, in the embodiment shown, at step 324, a visual representation of the component model can be output at a user interface (e.g., at a human-machine interface 42 of an interfacing controller 14g). In this embodiment, at step 328, a control input can be received at the user interface. In the depicted embodiment, at step 332, one or more of the controllable functions can be actuated based at least in part on the data contained in the model and/or the received control input. In some embodiments, at step 336, a visual representation of the BOP component model can be output at a user interface (e.g., which may or may not reflect any actuation at step 332).

As will be apparent to one of ordinary skill in the art, the illustrative simulations described above and other similar simulations may be performed for any number of BOP components and/or systems, whether performed by multiple simulating controllers or a single simulating controller, and any steps can be performed in parallel and/or in series. For example, in some embodiments, one or more BOP components and/or systems may be simulated simultaneously, and one or more of the BOP components and/or systems may be selected for actuation (e.g., at interfacing controller 14g).

As mentioned above, in the embodiment shown, at least one controller may comprise a human-machine interface 42 (e.g., interfacing controller 14g) (e.g., to monitor, control, and/or analyze a BOP component and/or system). Human-machine interfaces of the present BOP control systems can comprise any suitable interfacing devices, such as, for example, displays, such as monitors and/or the like, input devices, such as, for example, keyboards, mice, touch pads, track balls, touchscreens, and/or the like, computers, such as, for example, laptops, desktops, and/or the like, and/or the like. In some embodiments, an interfacing controller may comprise a physical three-dimensional (3D) model of a BOP component and/or system (e.g., a scale model of a BOP component and/or system), that may change states (e.g., move) to correspond to state changes and/or actuations of an actual BOP component and/or system (e.g., a subsea BOP component and/or system). Interfacing controllers of the present BOP control systems can be configured to perform any suitable function, and the following examples are provided merely for illustrative purposes.

For example, in some embodiments, an interfacing controller (e.g., 14g) can be configured to control a BOP component and/or system (e.g., with or without communication with a simulating controller). For example, an interfacing controller 14g may receive user input (e.g., via an input device), and based at least in part on the user input, communicate a command to a BOP component and/or system (e.g., whether or not through an actuation controller, such as, for example, 14e). To illustrate, a user may enter a command at an interfacing controller 14g, such as, for example, close a ram on a BOP, and the interfacing controller may communicate a ram close command to the BOP ram and/or to an actuation controller 14e of the BOP ram. In this example, the ram close command may cause actuation of an electrically actuated pilot stage valve to cause a hydraulically actuated valve to communicate hydraulic fluid to the BOP ram to close the BOP ram.

By way of further example, in some embodiments, an interfacing controller (e.g., 14g) can be configured to read and/or record information transmitted by and/or recorded by a controller (e.g., a sensing controller 14c, a data logging controller 14d, a simulating controller 14b, and/or the like), and may display the information and/or a visual representation of the information (e.g., a model) (e.g., via human-machine interface 42), process this information (e.g., via implementing processor(s) 18 of the interfacing controller), and/or the like.

In the depicted embodiment, at least one controller 14 comprises processor-executable software, sensors, and/or the like for detecting a kick in a BOP component and/or system (e.g., kick detecting controller 14a) (e.g., configured to control, monitor, and/or analyze a BOP component and/or system). For example, a kick detecting controller 14a may communicate with a BOP component and/or system and detect a kick within the BOP component and/or system (e.g., by receiving and/or processing information captured by one or more sensors of the kick detecting controller). In this example, the kick detecting controller 14a may be configured to (e.g., automatically) actuate and/or communicate to an actuating controller (e.g., 14e) that may be configured to (e.g., automatically) actuate the BOP component and/or system to control the kick.

Other suitable controllers can include, but are not limited to including, valve aging models, energy estimators, and/or the like.

In the embodiment shown, BOP control system 10 comprises an operating system 16 configured to manage controllers 14 and/or communication to, from, amongst, and/or between the controllers (e.g., function as a broker for communications within and/or through BOP control network 22). In some embodiments, an operating system 16 may be comprised, at least in part, by one or more controller(s) 14. However, in some embodiments, such management of controllers 14 may be performed by one or more controller(s) 14 (e.g., without an operating system 16), and operating system 16 may be omitted.

In the depicted embodiment, each controller 14 that is configured to transmit information associated with a BOP component and/or system through BOP control network 22 may be configured to transmit the information during one or more respective time interval(s) (e.g., 46a-46f), sometimes referred to collectively as “time intervals 46” (e.g., which may be assigned to each controller by other controllers 14, such as, for example, asset utilization estimating controller 14h, an operating system 16, and/or the like, described in more detail below). Such a time-triggered approach (e.g., which in some embodiments, may be implemented in a similar fashion as to a time division multiple access (TDMA) access method) may enhance BOP control system reliability, availability, and/or fault tolerance, for example, by mitigating the risk of information loss due to queuing, undesired duplication of information (e.g., commands) (e.g., transmitted information may be time-stamped), provide for relatively straight-forward fault detection, and/or the like. In part due to the flexibility provided by the present BOP control systems, any suitable controller(s) 14 can be assigned any suitable respective time interval(s) 46, and the following examples of controller(s) and assigned respective time interval(s) are provided merely by way of illustration.

For example, in some embodiments, the present BOP control systems are configured such that each of one or more controllers 14 can only transmit information through BOP control network 22 during the respective time interval(s) 46 assigned to the controller. To illustrate, in this embodiment, sensing controller 14c may be assigned time intervals 46b and 46c, and sensing controller 14c may only be permitted to transmit information through BOP control network during time intervals 46b and 46c.

By way of further example, in some embodiments, at least two controllers 14 are assigned overlapping respective time interval(s). To illustrate, in the depicted embodiment, a data logging controller 14d may be assigned a time interval 46e, and a simulating controller 14b may be assigned a time interval 46e. In this way, data logging controller 14d and simulating controller 14b may be allowed to transmit information through BOP control network 22 during the same time interval (e.g., simultaneously). To further illustrate, interfacing controller 14g may be assigned each time interval 46a-46f (e.g., which necessarily overlaps, at least in part, time interval(s) 46 assigned to any other controllers 14). In this way, interfacing controller 14g may allow commands to be transmitted (e.g., from a user via human-machine interface 42) to other controller(s) 14 at any suitable and/or desired time. Thus, in some embodiments, interfacing controller 14g can, in effect, override other operations of BOP control system 10 (e.g., in emergency situations).

By way of further example, in some embodiments, time intervals 46 can be assigned to each of one or more controller(s) such that no time interval respective to any one of the one or more controllers in communication with a first set of one or more BOP components and/or systems overlaps any other time interval respective to any one of the one or more controllers in communication with a second set of one or more BOP components and/or systems, the first set of BOP components and/or systems different than the second set of BOP components and/or systems (e.g., the first set comprising at least one BOP component and/or system not comprised by the second set). In this way, communication to, from, amongst, and/or between controllers 14 in communication with differing sets of BOP components and/or systems can be independently monitored, controlled, and/or analyzed.

By way of further example, in some embodiments, a controller 14 may transfer information through the BOP control network during time interval(s) 46 assigned to other controllers (e.g., and/or the controller may be reassigned time interval(s) that may overlap the time interval(s) assigned to the other controllers), such as, for example during emergency situations (e.g., when immediate control of one or more BOP components and/or systems may be desired).

While not required in every embodiment, in the embodiment shown, the respective time interval(s) assigned to each controller reoccur periodically (e.g., may repeat after a time period equal to the sum of all time interval(s) assigned to controllers 14). In this embodiment, each of the time interval(s) 46 may or may not comprise the same duration. For example, in this embodiment, a time interval 46a may be 10 milliseconds (ms), a second time interval 46b may be 10 ms, and a third time interval 46c may be 20 ms. Assignment of each time interval 46 and/or the duration of each time interval 46 may be selected dependent on the controller(s) 14 to which the time interval is assigned. For example, a simulating controller 14b may require a relatively longer period of time to perform a simulation function than a data logging controller 14d may require to perform a logging function, and thus the simulating controller may be assigned a longer time interval (e.g., or more time interval(s)) than the data logging controller. In some embodiments, each of controllers 14 which are assigned a time interval 46 may comprise and/or be in communication with a clock (e.g., to synchronize the controllers).

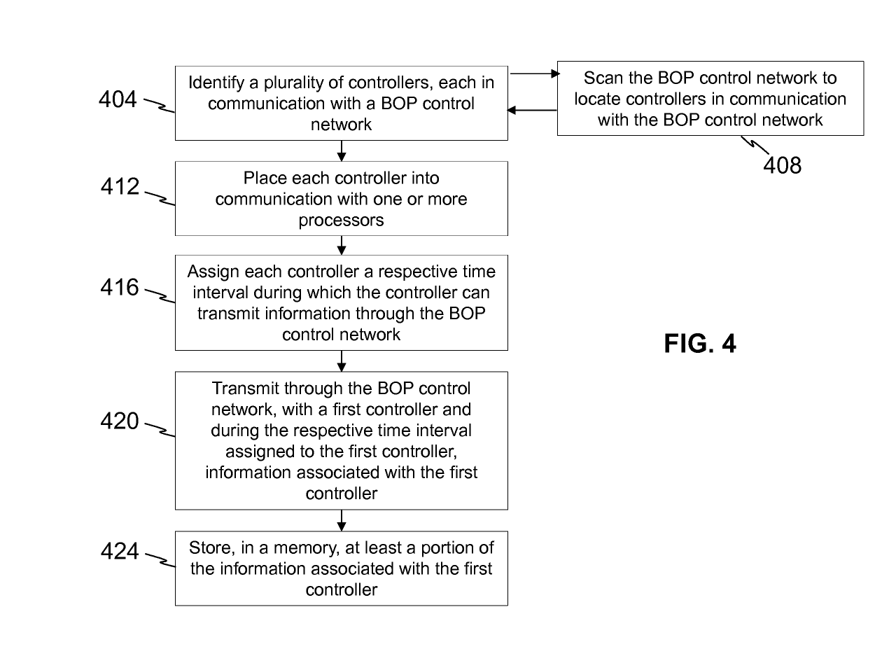

Referring additionally to FIG. 4, shown is one embodiment of the present methods for controlling, monitoring, and/or analyzing one or more BOP components and/or systems. The following description is provided only by way of example, and not by way of limitation. In the embodiment shown, at step 404, a plurality of controllers can be identified that are in communication with a BOP control network (e.g., 22). Such identification can be accomplished through any suitable method. For example, in this embodiment, a BOP control network (e.g., 22) can be scanned (e.g., with an operating system 16, controller(s) 14, processor(s) 18, and/or the like) to locate controllers in communication with the BOP control network (e.g., step 408). In some embodiments, such identification can be accomplished (e.g., solely and/or additionally) by receiving a notification and/or announcement from controllers in communication with the BOP control network. In these embodiments, a notification and/or announcement from a controller may indicate that the controller is in communication with the BOP control network, a BOP component and/or system, and/or the like, is implemented (e.g., by processor(s) 18), is functioning and/or is capable of functioning, and/or the like.

In the depicted embodiment, at step 412, one or more controllers (e.g., 14) can be placed into communication with (e.g., implemented by) one or more processors (e.g., 18). In the embodiment shown, at step 416, one or more controllers can each be assigned one or more respective time interval(s) (e.g., 46) during which the controller can transmit information through the BOP control network. While not required in every embodiment, at step 420, in this embodiment, one or more controllers can transmit information associated with the one or more controllers through the BOP control network, during the respective time interval(s) assigned to the one or more controllers. Also not required in every embodiment, in this embodiment, at step 424, a portion of the information associated with the first controller can be stored in a memory (e.g., 12, 20, 38, and/or the like).

In the embodiment shown, management of controllers 14 and/or communication to, from, amongst, and/or between the controllers may be facilitated by a virtual BOP control network 50 (e.g., alone and/or in conjunction with other components, such as, for example an operating system 16 and/or a manager application, described below). In this embodiment, virtual BOP network 50 may comprise a virtual representation (e.g., stored in a memory, such as, for example, 12, 20, 38, and/or the like) of BOP control network 22 (e.g., subnetwork(s) 26, controller(s) 14, processor(s) 18, and/or the like).

In the embodiment shown, virtual BOP control network 50 can be managed and/or monitored, for example, to ensure that no two controllers 14 inadvertently transfer information through BOP control network 22 simultaneously. To illustrate, an operating system 16, controller 14 (e.g., an asset utilization estimating controller 14h), and/or the like may reference virtual BOP control network 50, for example, when assigning time interval(s) 46 to controller(s) 14. In this way, for example, if a controller 14, implemented by a processor 18a in subnetwork 26a, is assigned a respective time interval 46a, virtual BOP control network 50 can facilitate BOP control system 22 in ensuring that no other controller 14 is inadvertently assigned time interval 46a, regardless of whether the other controller is implemented by a processor in subnetwork 26a, 26b and 26c. For yet further example, if a controller (e.g., 14j) is added to the one or more controllers 14, virtual BOP control network 50 can be referenced to avoid inadvertently assigning the added controller a time interval 46 already assigned to an existing controller. In other words, virtual BOP control network 50 can comprise a reference to which controller(s), operating system(s), processor(s), other components and/or the like can refer to receive information regarding BOP control network 22.

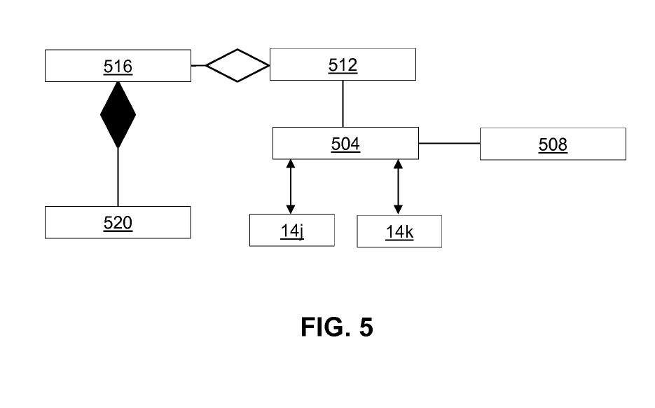

Referring to FIG. 5, shown is a diagram of one embodiment of a file access architecture suitable for use in some embodiments of the present BOP control systems (e.g., 22). In this embodiment, a manager application 504 (e.g., of a virtual BOP control network 50, operating system 16, controller 14, and/or the like) can be configured to manage communication of information to, from, amongst, and/or between controllers (e.g., 14j and/or 14k). In the embodiment shown, manager application 504 may check whether a requesting controller is authorized to send and/or receive information, and/or whether any transmitting controllers are authorized to transmit the information (e.g., by reference an authorization database 508, which may contain information on controller(s) and/or permissions of controller(s)). To illustrate, in this embodiment, manager application 504 can receive a request from controller 14j receive a BOP component and/or system model. In this example, manager application 504 can reference authorization database 508 to determine whether controller 14j is authorized to receive the BOP component and/or system model. If controller 14j is authorized to receive the BOP component and/or system model, manager application may access a library 512, which may contain files 516, which, for example, may contain the requested BOP component and/or system model 520.

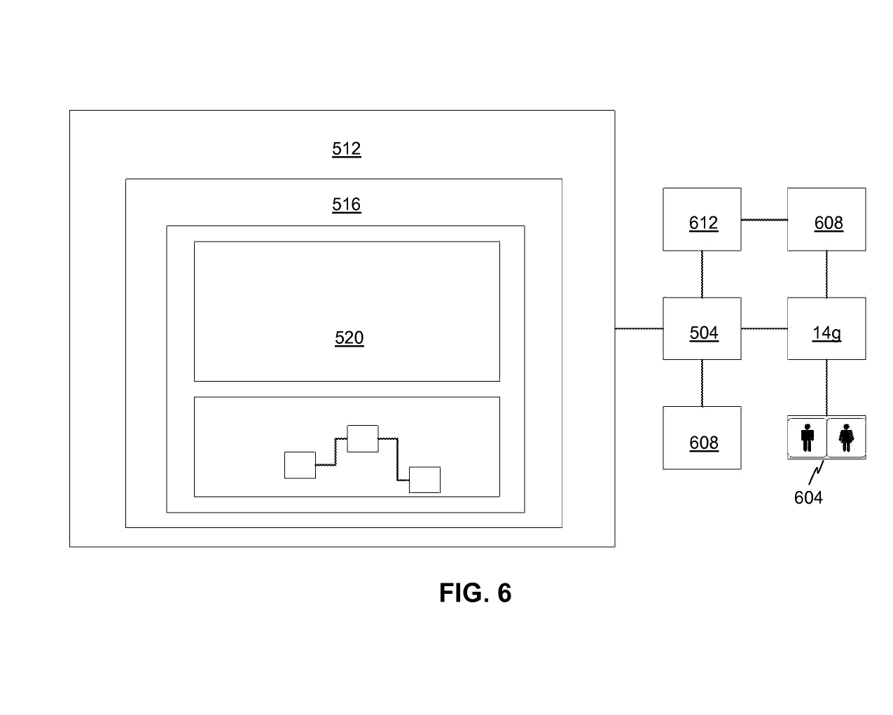

Referring to FIG. 6, shown is a diagram of one embodiment of a file access architecture suitable for use in some embodiments of the present BOP control systems (e.g., 22). In the embodiment shown, similarly to as described above, a manager application 504 can be configured to manage communication of information to, from, amongst, and/or between controllers (e.g., 14g). To illustrate, in this example, a user 604 may setup a user account (e.g., through execution of user setup application 608), and permissions may be assigned to the user account (e.g., by execution of access rule application and/or service 612) (e.g., facilitated by user interfacing with a human machine interface 42 of an interfacing controller 14g). In some embodiments, information associated with the user account and permissions may be stored in an authorization database (e.g., 508, FIG. 5). In this example, user 604 may request a BOP component and/or model from BOP control network 22 (e.g., facilitated by interfacing controller 14g). In the depicted example, manager application 504 can receive the request (e.g., from interfacing controller 14g), and determine whether the user and/or interfacing controller are authorized to access the requested BOP component and/or system model (e.g., by referencing access rule application and/or service 612 and/or an authorization database 508). In this example, if the user and/or interfacing controller are authorized to receive the BOP component and/or system model, manager application 504 may access a library 512, which may contain files 516, which, for example, may contain the requested BOP component and/or system model 520.

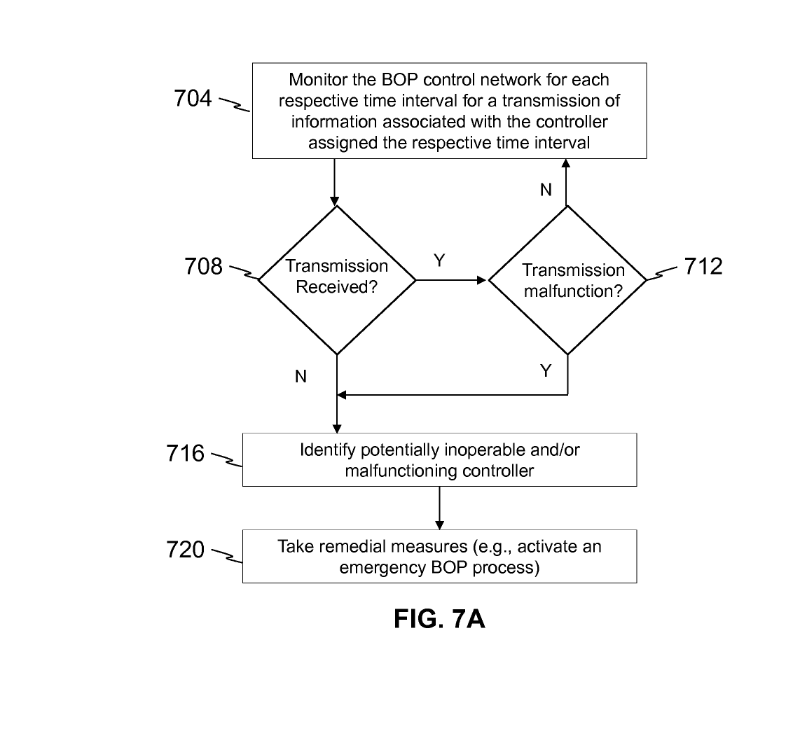

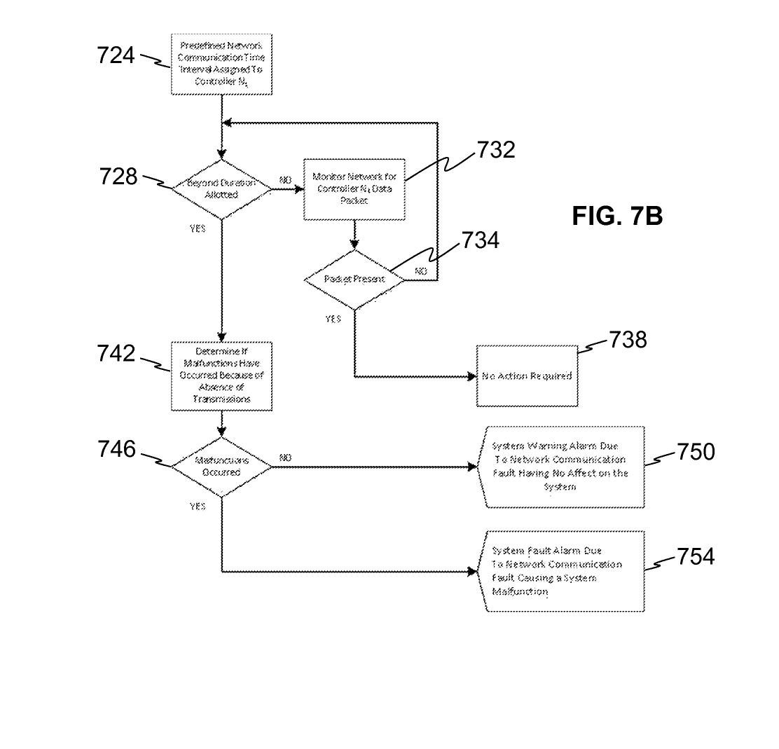

FIG. 7A depicts one embodiment of the present methods for controlling, monitoring, and/or analyzing a BOP component and/or system. For example, in the embodiment shown, at step 704, a BOP control network (e.g., 22) can be monitored during each time interval (e.g., 46) for a transmission of information associated with the controller assigned the respective time interval. Such monitoring can be performed by, for example, a controller (e.g., 14), an operating system (e.g., 16), and/or the like. At step 708, in this embodiment, if a transmission was received, the transmission may then be analyzed at step 712 to determine if the transmission indicates a malfunction (e.g., the transmission communicates a malfunction, is uninterpretable, unexpected, and/or the like). In the depicted embodiment, if no transmission was received and/or a received transmission indicates a malfunction, at step 716, the potentially inoperable and/or malfunctioning controller can be identified (e.g., as the controller from which a transmission was expected during the monitored time interval). In some embodiments, at step 720, remedial measures can be undertaken (e.g., activating an emergency BOP process, such as BOP ram activation, sending a notification and/or alarm to a user interface, other controller, and/or the like, requesting the potentially inoperable and/or malfunctioning controller to re-send the transmission, and/or the like).

FIG. 7B depicts one embodiment of the present methods for controlling, monitoring, and/or analyzing a BOP component and/or system. In the embodiment shown, at step 724, a time interval (e.g., 46) can be assigned to a controller (e.g., 14). In this embodiment, steps 728, 732, and 734 may be repeated to monitor the BOP control network during the time interval assigned to the controller for a transmission from the controller, until the time interval expires and/or a transmission (e.g., packet) is detected. In the depicted example, if a packet is detected at step 734, no further action may be required at step 738. However, if the time interval expires, and no transmission was detected, at step 742, in this embodiment, whether the absence of a transmission was a result of a malfunction can be determined. In the embodiment shown, at step 746, if malfunctions have not occurred, at step 750, a system warning can be issued (e.g., to an interfacing controller 14g) that indicates a fault has occurred that does not adversely affect the BOP control system. If a malfunction has occurred as determined at step 746, in this embodiment, at step 754, a system warning can be issued (e.g., to an interfacing controller 14g) that a fault has occurred that does adversely affect the BOP control system (e.g., a hierarchical alarm process).

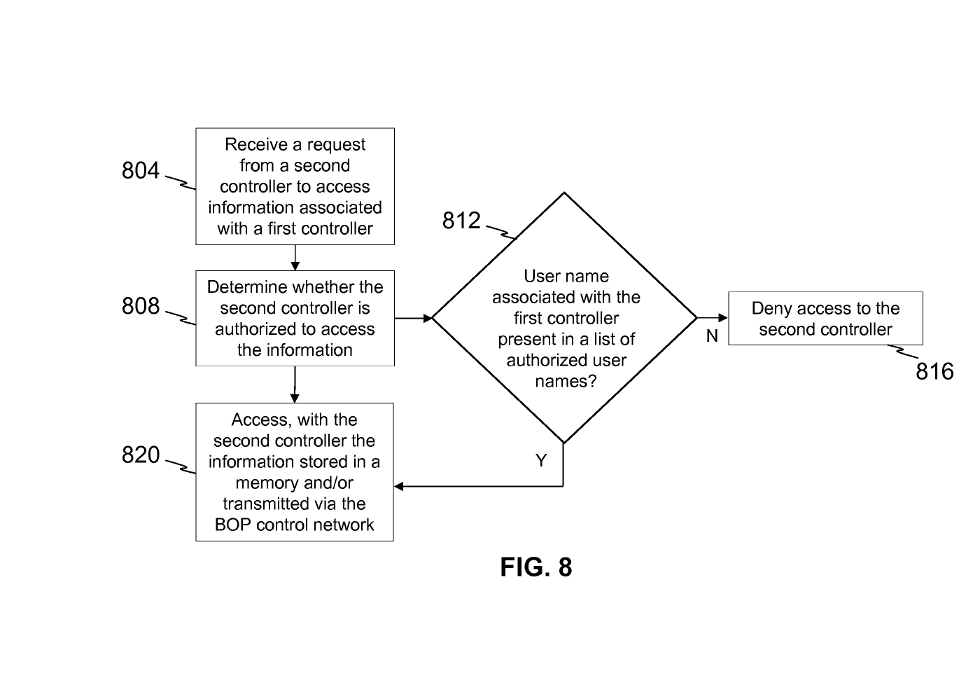

Referring now to FIG. 8, shown is one embodiment of the present methods for accessing information. In the embodiment shown, at step 804, a request can be received (e.g., by a controller 14, an operating system 16, a virtual BOP control network 50, and/or the like) from a second controller (e.g., an interfacing controller 14g) to access information associated with a first controller (e.g., a data logging controller 14d). At step 808, in this embodiment, a determination is made as to whether the second controller is authorized to access the requested information. For example, in the depicted embodiment, at step 812, a user name associated with the second controller can be compared to a list of authorized user names (e.g., which may be contained in an authorization database, such as, for example, 508). In the embodiment shown, if the second controller is not authorized to access the requested information (e.g., a user name associated with the second controller is not present in a list of authorized user names), then, at step 816, access can be denied to the second controller. In this embodiment, at step 820, if the second controller is authorized to access the requested information, the second controller can access the information (e.g., whether the information is stored in a memory, such as, for example, 12, 20, 38, and/or the like, and/or transmitted via the BOP control network). For example, in some embodiments, the second controller may access the information associated with the first controller by reading the information transmitted by the first controller through the BOP control network during a time interval (e.g., 46) assigned to the first controller for transmission of information. In some embodiments, the second controller may be provided (e.g., by a controller 14, an operating system 16, a virtual BOP control network 50, and/or the like) with the time interval (e.g., 46) assigned to the first controller for transmission of information.

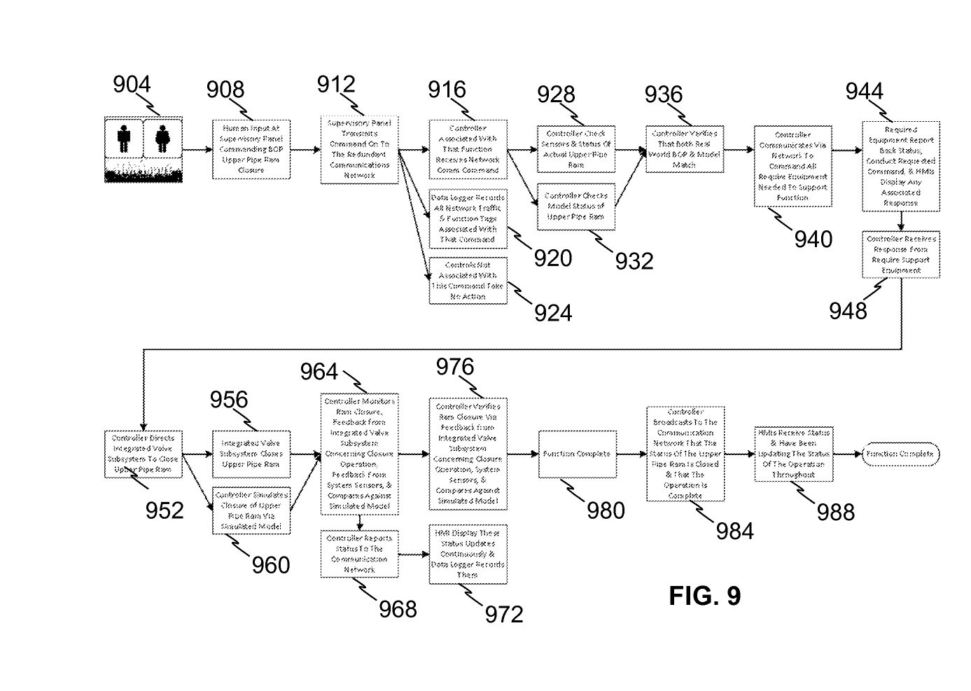

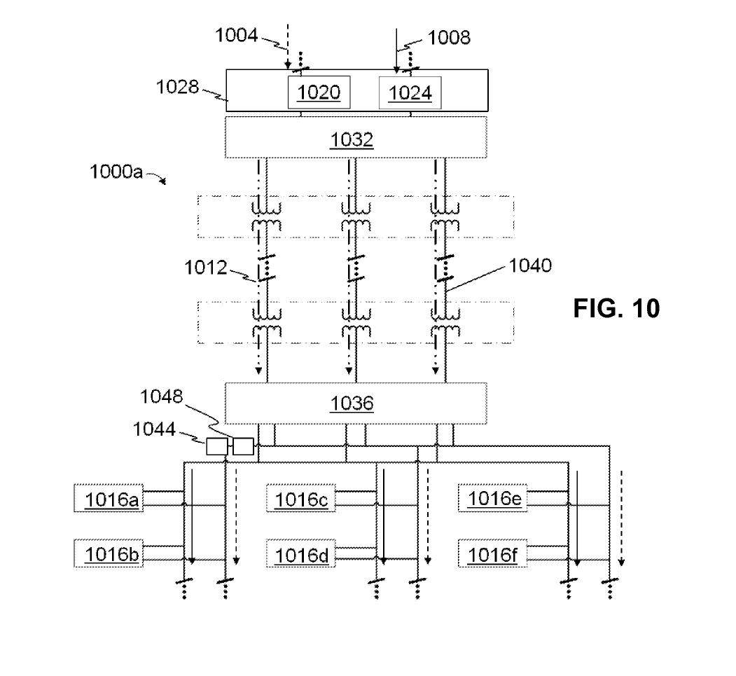

FIG. 9 is a flow chart of one embodiment of the present methods for controlling, monitoring, and/or analyzing one or more BOP components and/or systems. The following description is provided merely by way of illustration. In the embodiment shown, at step 904, a controller (e.g., an interfacing controller 18g) may monitor for input. At step 908, in this embodiment, input can be received, such as, for example, a command to close an upper pipe ram BOP. In the embodiment shown, at step 912, the controller can transmit the command to a BOP control network (e.g., 22) (e.g., during a respective time interval 46 assigned to the controller).

In this embodiment, steps 916, 920, and/or 924 may be performed substantially simultaneously. In the depicted embodiment, at step 916 a controller associated with the command and/or commanded BOP component and/or system (e.g., an actuating controller 14e) can receive the command via the network (e.g., if the command and/or controller transmitting the command are authorized to do so). At step 920, a controller (e.g., a data logging controller 14d) can record information transmitted through the BOP control network and/or stored in a memory (e.g., 12, 20, 38, and/or the like) (e.g., such as, for example, the command transmitted by interfacing controller 14g). As shown, at step 924, controllers (e.g., 14) not associated with the information transmitted through the BOP control network may take no action.

In this embodiment, at steps 928 and/or 932, the controller associated with the command and/or commanded BOP component and/or system can check the status of the commanded BOP component and/or system (e.g., by reading data captured by any sensors of the controller and/or communicating with a sensing controller, such as, 14c) and/or a model of the commanded BOP component and/or system (e.g., by communicating with a simulating controller, such as, 14b). At step 936, in the embodiment shown, the controller associated with the command and/or commanded BOP component and/or system may verify that the model of the commanded BOP component and/or system matches the status of the commanded BOP component and/or system.

In this embodiment, at step 940, the controller can communicate with other controllers (e.g., 14) which may be associated with the command. At 944, as shown, any other controllers may respond to the controller (e.g., and these responses may be indicated on human machine interface 42 of an interfacing controller 14g). In the depicted embodiment, at step 948, the controller can receive responses from the other controllers.

At step 952, in this embodiment, the controller associated with the command and/or commanded BOP component and/or system can direct the commanded BOP component and/or system (e.g., whether or not through an actuating controller 14e) to perform the commanded function (e.g., to close the upper pipe ram). In this embodiment, at step 956, the commanded BOP component and/or system may actuated as commanded (e.g., by closing the upper pipe ram BOP), and, at step 960, the actuation may be simulated (e.g., simultaneously) (e.g., by a simulating controller 14b).

In this embodiment, the controller associated with the command and/or commanded BOP component and/or system can monitor the commanded BOP component and/or system during actuation at step 964 (e.g., with any sensors of the controller and/or by communication with a sensing controller 14c). At step 968, in the embodiment shown, the controller can communicate a status of the commanded BOP component and/or system (e.g., which may be displayed at a human machine interface 42 of an interfacing controller 14g at step 972).

As shown, at step 976, the controller associated with the command and/or commanded BOP component and/or system can verify that the commanded BOP component and/or system properly performed the commanded function (e.g., and/or may verify that a model of the commanded BOP component and/or system matches the status of the commanded BOP component and/or system).

In this embodiment, at step 980, the commanded BOP component and/or system may have completed the commanded function. At step 984, the controller associated with the command and/or commanded BOP component and/or system can communicate through the BOP control network that the commanded function has been completed (e.g., which may be displayed at a human machine interface 42 of an interfacing controller 14g at step 988).

Referring now to FIG. 10, shown therein and designated by the reference numeral 1000a is one embodiment of the present BOP power and/or data communication systems. Embodiments of the present communication systems can be configured to provide at least one of power (e.g., signals indicated by dashed arrows 1004), data (e.g., signals indicated by solid arrows 1008), and/or a combined power and data (e.g., signals indicated by dash-dot-dot arrows 1012) to one or more (e.g., subsea) controllers (e.g., 1016a-1016f), sometimes referred to collectively as controllers 1016. In some embodiments, one or more controllers 1016 may comprise a controller 14 and/or any and/or all of the features described above for controllers 14. In some embodiments, one or more controllers 1016 may comprise processor(s) (e.g., 18). To illustrate, in the depicted embodiment, controller 1016a may comprise a processor that implements and/or comprises a sensing controller 14c (e.g., that captures data indicative of hydraulic pressure in a BOP ram), a controller 1016b may comprise a processor that implements and/or comprises an actuating controller 14e (e.g., that actuates a BOP ram), and/or the like.

In the embodiment shown, communication system 1000a comprises an amplifier 1020 (e.g., a step-up transformer) configured to increase the amplitude of at least one of a power signal, a data signal, and combined power and data signal. In this embodiment, communication system 1000a comprises a frequency converter (e.g., frequency changer) 1024 configured to increase the frequency of at least one of a power signal, a data signal, and a combined power and data signal. In communication system 1000a, amplifier 1020 and/or frequency converter 1024 may be contained in a signal conditioning circuit 1028 (e.g., which, in some embodiments, may also include a signal coupler 1032 and/or signal decoupler 1036).

For example, some of the present methods for providing high frequency power to a subsea BOP control system comprise providing an alternating current (AC) power signal, increasing the frequency (e.g., with a frequency converter 1024) and the amplitude (e.g., with an amplifier 1020) to create a high power AC power signal, and transmitting the high power AC signal (e.g., via cables 1040, described below) to a subsea BOP control system (e.g., to one or more controllers 1016). In some embodiments, increasing the frequency and/or amplitude of the AC power signal is performed offshore and above-sea. In some embodiments, at least one of the AC power signal and the high power AC power signal is coupled with a data signal.

While not required in every embodiment, in the depicted embodiment, communication system 1000a comprises a signal coupler 1032 configured to receive a power and a data signal, and couple the power signal and the data signal into a combined power and data signal. In this embodiment, signal coupler 1032 is configured to inductively couple a power signal and a data signal into a combined power and data signal (e.g., by inductively modulating the power signal with the data signal). In other embodiments, such coupling can be accomplished through any suitable method, such as, for example, using a broadband over power lines (BPL) standard, a digital subscriber line (DSL) standard, capacitive coupling, frequency superimposition (e.g., superimposing a data signal over a power signal having a differing frequency than the data signal, such as, for example, superimposing a higher frequency and lower amplitude data signal over a lower frequency and higher amplitude power signal), and/or the like. Signal couplers of the present communication systems can be disposed at any suitable location, such as, for example, subsea (e.g., on a BOP component and/or system), above-sea and offshore (e.g., on a drilling rig), and/or onshore (e.g., at an onshore control station). At least in part due to data and power signal coupling, reliability, availability, and/or fault tolerance of some embodiments of the present communication systems may be increased, for example, by reduce the number of cables, connectors, and/or the like within the system.

For example, some embodiments of the present methods for distributing power and data to a subsea BOP control system comprise coupling a power signal and a data signal to create a combined power and data signal (e.g., with signal coupler 1032), and transmitting the combined power and data signal to the subsea BOP control system (e.g., to one or more controllers 1016). In some embodiments, the power signal and the data signal are coupled offshore and above-sea. In some embodiments, the power signal and the data signal are coupled via inductive coupling.

In the embodiment shown, system 1000a comprises a subsea signal decoupler 1036 configured to receive a combined power and data signal and decouple the power and the data signal. In this embodiment, signal decoupler 1036 is in electrical communication with signal coupler 1032 (e.g., via one or more cables 1040). In the depicted embodiment, signal decoupler 1036 is configured to inductively decouple a power signal and a data signal (e.g., from a combined power and data signal). However, in other embodiments, such decoupling can be accomplished through any suitable method, such as, for example, using a BPL standard, a DSL standard, capacitive decoupling, signal decomposition based on frequency, and/or the like. Signal decouplers of the present communication systems can be disposed at any suitable location, such as, for example, subsea (e.g., on a BOP component and/or system, such as on an LMRP), above-sea and offshore (e.g., on a drilling rig), and/or onshore (e.g., at an onshore control station).

For example, some embodiments of the present methods for distributing power and data to a subsea BOP control system comprise decoupling a power signal and a data signal from a combined power and data signal (e.g., with a signal decoupler 1036). In some embodiments, the decoupling of the power signal and the data signal is performed subsea. In some embodiments, the power signal and the data signal are decoupled via inductive decoupling.

In the embodiment shown, one or more cables 1040 can be configured to transmit power, data, and/or power and data to the one or more controllers 1016. For example, in this embodiment, cables 1040 are disposed in communication between signal coupler 1032 and signal decoupler 1036. However, in other embodiments (e.g., without a signal coupler and/or signal decoupler), cables 1040 can be disposed in communication between a power and/or signal source and controllers 1016. Through configuration of cables 1040, communication system 1000a may provide for increased reliability, availability and/or fault tolerance. For example, the depicted embodiment comprises at least two cables 1040 disposed in parallel. In this way, if one cable fails and/or becomes inoperable to transmit data and/or power, at least one other cable may be available to transmit the data and/or power.

For example, some embodiments of the present methods for providing high frequency power to a subsea BOP control system comprise transmitting a high power AC power signal to a subsea BOP control system (e.g., to one or more controllers 106) via two or more electrically parallel cables (e.g., 1040).

Electrical connectors of the present communication systems can comprise any suitable connector. For example, cables 1040 may be inductively coupled to amplifier 1020, frequency converter 1024, signal coupler 1032, signal decoupler 1036, controllers 1016, and/or the like (e.g., via inductive electrical couplers). Such inductive electrical couplers may minimize the risk of connection failure (e.g., due to fluid ingress).

As mentioned above, some embodiments of the present communication systems are configured to provide power, data, and/or combined power and data to one or more controllers 1016 (e.g., which may be disposed subsea). For example, in this embodiment, one or more subsea controllers 1016 are in electrical communication with the signal decoupler, and are configured to receive at least a portion of a power signal and at least a portion of a data signal. In the depicted embodiment, at least two of the controllers are disposed in parallel (e.g., as shown, controllers 1016a and 1016b are in parallel with controllers 1016c and 1016d). In the embodiment shown, at least two of the controllers are disposed in series (e.g., as shown, controllers 1016e and 1016f are disposed in series).

Embodiments of the present communication systems can be configured to provide power signals, data signals, and/or combined power and data signals in any suitable configuration (e.g., direct current (DC), alternating current (AC), and/or the like). In this embodiment, communication system 1000a comprises a subsea rectifier 1044 configured to produce a direct current (DC) signal from at least one of an AC power signal, data signal, and combined power and data signal. Distribution of DC signals (e.g., power signals) may be less complex than the distribution of AC signals and/or DC signals may be readily compatible with other DC signals, for example, provided by batteries.

For example, some embodiments of the present methods for providing high frequency power to a subsea BOP control system comprise rectifying (e.g., with rectifier 1044) a high power AC power signal to create a DC power signal and distributing the DC power signal to one or more components of the subsea BOP control system (e.g., to one or more controllers 1016). In some embodiments, the rectifying is performed subsea.

In some embodiments, the amplitude of a power signal, data signal, and/or combined power and data signal may be reduced (e.g., via a step-down transformer 1048) before being distributed to one or more controllers 1016. In some embodiments, the frequency of a power signal, data signal, and/or combined power and data signal may be reduced (e.g., via a frequency converter and/or frequency changer) before being distributed to one or more controllers 1016.

Any suitable components of the present communication systems may be redundant. For example, in some embodiments, each cable 1040 is in electrical communication with a respective amplifier 1020 and/or step down transformer 1048.

As mentioned above, any and/or all of the components of some embodiments of the present communication systems (e.g., 1000a) may form part of some embodiments of the present BOP control networks (e.g., 22). For example, amplifier(s) (e.g., 1020), frequency converter(s) (e.g., 1024), signal coupler(s) (e.g., 1032), cable(s) (e.g., 1040), signal decoupler(s) (e.g., 1036), rectifier(s) (e.g., 1044), step down transformer(s) (e.g., 1048), and/or the like may form part of a bridge 30, a subnetwork 26, and/or the like (e.g., to enhance transfer of information and/or power to and/or from processors 18a-18c and/or controllers 14 implemented by processors 18a-18c, either of which may be disposed subsea). For merely illustrative purposes, a power and a data signal may be provided from an onshore control station via subnetwork 26c, any power and signal coupling may be facilitated by a signal coupler 1032 forming part of bridge 30b and/or 30a and disposed on a drilling rig and/or on a drilling riser, the amplitude and/or frequency of a power signal, data signal, and/or coupled power and data signal may be increased by an amplifier 1020 and/or frequency converter 1024 forming part of bridge 30b and/or 30a and disposed on the drilling rig and/or drilling riser, a power signal, data signal, and/or coupled power and data signal may be transmitted via cables 1040 forming part of bridge 30a and/or subnet 26a, the amplitude and/or frequency of a power signal, data signal, and/or coupled power and data signal may be decreased by a step-down transformer 1048 and/or frequency converter forming part of bridge 30a and/or subnetwork 26a, an AC power, data, and/or combined power and data signal can be converted to a DC signal by a rectifier 1044 forming part of bridge 30a and/or subnetwork 26a, any coupled power and data signal may be decoupled by a signal decoupler 1036 forming part of bridge 30a and/or subnet 26a, and/or the like.

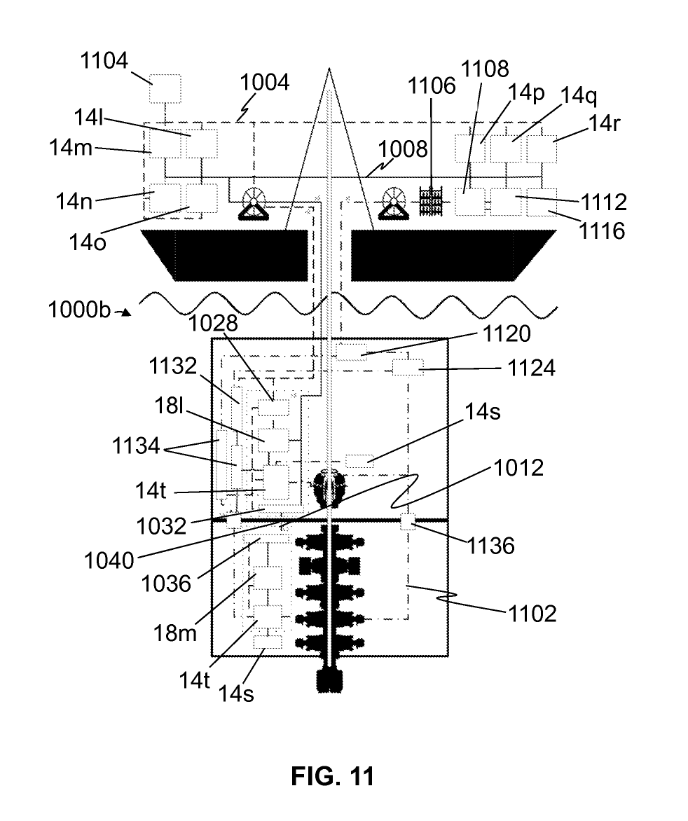

FIG. 11 is a diagram of one embodiment 1000b of the present BOP power and/or data communication systems. Communication system 1000b may be substantially similar to communication system 1000a, and may possess any and/or all of the features described above with respect to communication system 1000a. In this embodiment, communication system 1000b is shown in conjunction with a hydraulics system (e.g., hydraulic fluid flow indicated by dash-dot arrows 1102). While the present communication systems and/or BOP control systems can be used in conjunction with any suitable hydraulics system, the following description is provided merely by way of illustration. For example, in this embodiment, hydraulic fluid can be provided by one or more hydraulic power unit(s) 1108, one or more subsea pump(s) 1132, and/or the like. Examples of subsea pumps suitable for use with some embodiments of the present control and/or power and/or data communication systems are disclosed in co-pending U.S. patent application Ser. No. 14/461,342, filed on Aug. 15, 2014 and entitled “SUBSEA PUMPING APPARATUSES AND RELATED METHODS,” which is hereby incorporated by reference in its entirety. Examples of manifolds suitable for use with some embodiments of the present control and/or power and/or data communication systems are disclosed in a co-pending U.S. Patent Application filed on the same day as the present application and entitled “MANIFOLDS FOR PROVIDING HYDRAULIC FLUID TO A SUBSEA BLOWOUT PREVENTER AND RELATED METHODS,” which is hereby incorporated by reference in its entirety. Other hydraulic system components can include, but are not limited to including, hydraulic fluid mixing unit(s) 1112, diverter unit(s) 1116, hydraulic stab(s) 1136, accumulator(s) 1106, hydraulic rail(s) 1134, fluid valve package(s) 1120, reservoir(s) 1124, and/or the like.

In this embodiment, power signals may be provided by an uninterruptible power source 1104. As shown, signal conditioning circuit 1028 (e.g., containing an amplifier 1020 and/or frequency converter 1024) may be disposed subsea (e.g., on a LMRP). In the depicted embodiment, at least one controller and/or processor is configured to receive (e.g., separate and uncoupled) power signals and data signals. For example, in this embodiment, a processor 181 is configured to receive a power signal from signal conditioning circuit 1028, and a data signal from one or more controllers (e.g., 14l-14r). In the depicted embodiment, processor 181 is in communication with (e.g., implements) a manifold controller 14t (e.g., an actuating controller, for example, configured to cause actuation of an annular).

In the embodiment shown, a signal coupler 1032 is disposed subsea (e.g., disposed on an LMRP), and is configured to couple a power signal (e.g., from signal conditioning circuit 1028) and a data signal (e.g., from one or more controllers, 14l-14r) into a combined power and data signal. In this way, a combined power and data signal 1012 can be transmitted to, for example, a BOP stack via cables 1040. In some embodiments, a signal conditioning circuit 1028, processor 181, controller 14t, and/or signal coupler 1032 can be replicated (e.g., triplicated) and disposed in parallel (e.g., between a power source, such as uninterruptible power source 1104, and a signal decoupler 1036) (e.g., for improved reliability, availability, and/or fault tolerance, for example, through redundancy).

In the embodiment shown, a signal decoupler 1036 is disposed subsea (e.g., disposed on a BOP stack) and is configured to receive the combined power and data signal (e.g., from signal coupler 1032 via cables 1040), and decouple the combined power and data signal into a power signal and a data signal. In this embodiment, a processor 18m is configured to receive a power signal and a data signal from signal decoupler 1036. In the depicted embodiment, processor 18m is in communication with (e.g., implements) a manifold controller 14t (e.g., an actuating controller, for example, configured to cause actuation of a ram). In some embodiments, a signal decoupler 1036, processor 18m, and/or controller 14t can be replicated (e.g., triplicated) and disposed in parallel (e.g., for improved reliability, availability, and/or fault tolerance, for example, through redundancy).

As shown, in this embodiment, communication system 1000b comprises one or more controllers 14. For example, in this embodiment, communication system 1000b may comprise one or more interfacing controllers (e.g., 14g) (e.g., supervisor panel 14l, a driller's panel 14m, a toolpusher's panel 14n, a diverter unit control panel 14p, a hydraulic power unit control panel 14q, a hydraulic fluid mixing unit control panel 14r, and/or the like), one or more data logging controllers (e.g., 14d) (e.g., remote monitor 14o, and/or the like), and/or the like, some and/or all of which may be in communication with (e.g., or be implemented by processor(s) 18 which may be in communication with) a BOP control network 22 via subnetwork 26b.

By way of further example, in the depicted embodiment, communication system 1000b may comprise one or more interfacing controllers (e.g., 14g) (e.g., ROV panels 14s, and/or the like), one or more actuating controllers (e.g., 14e) (e.g., manifold controllers 14t), and/or the like, some and/or all of which may be in communication with (e.g., or be implemented by processor(s) 18 which may be in communication with) a BOP control network 22 via subnetwork 26a.

If implemented in firmware and/or software, the functions described above (and below) may be stored as one or more instructions or code on a non-transitory computer-readable medium. Examples include non-transitory computer-readable media encoded with a data structure and non-transitory computer-readable media encoded with a computer program. Non-transitory computer-readable media are physical computer storage media. A physical storage medium may be any available medium that can be accessed by a computer. By way of example, and not limitation, such non-transitory computer-readable media can comprise RAM, ROM, EPROM, EEPROM, CD-ROM or other optical disk storage, magnetic disk storage or other magnetic storage devices, or any other physical medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above are also be included within the scope of non-transitory computer-readable media. Moreover, the functions described above may be achieved through dedicated devices rather than software, such as a hardware circuit comprising custom VLSI circuits or gate arrays, off-the-shelf semiconductors such as logic chips, transistors, or other discrete components, all of which are non-transitory. Additional examples include programmable hardware devices such as field programmable gate arrays, programmable array logic, programmable logic devices or the like, all of which are non-transitory. Still further examples include application specific integrated circuits (ASIC) or very large scale integrated (VLSI) circuits. In fact, persons of ordinary skill in the art may utilize any number of suitable structures capable of executing logical operations according to the described embodiments.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

### Alternative or Additonal Descriptions of Illustrative Embodiments

The following alternative or additional descriptions of features of one or more embodiments of the present disclosure may be used, in part and/or in whole and in addition to and/or in lieu of, some of the descriptions provided above.

Some embodiments of the present methods for managing the control and monitoring of a BOP comprise identifying a plurality of applications associated with the BOP, wherein the plurality of applications at least one of control and monitor a plurality of functions associated with the BOP, assigning processing resources to each of the plurality of applications, wherein the processing resources comprise at least one of a processor coupled to the BOP at the sea bed, a processor coupled to an offshore drilling rig in communication with the BOP, and a processor coupled to an onshore control station in communication with the offshore drilling rig and/or the BOP, scheduling the transfer of information from the plurality of applications onto a bus, and managing the access of the plurality of applications to the information transferred onto the bus.

In some embodiments, managing the access of the plurality of applications to the information transferred onto the bus comprises receiving a request from a first application to access the bus to retrieve information associated with a second application from the bus, determining whether the first application is authorized to access the requested information associated with the second application, providing access to the first application for the information on the bus associated with the second application when the first application is determined to have authorization, and revoking access to the first application for the information on the bus associated with the second application when the first application is determined to not have authorization. In some embodiments, determining whether the first application is authorized comprises comparing a user name associated with the first application to a list of authorized users. In some embodiments, providing access comprises providing the first application with a time interval during which the requested information associated with the second application will be available on the bus and transferring the requested information associated with the second application from a memory location associated with the second application to the first application.

Some embodiments comprise adding an application to the plurality of applications, assigning processing resources to the added application, storing the added application and/or information associated with the added application in the memory, scheduling the transfer of information from the added application onto the bus, and managing the access of the added application to the information transferred onto the bus.

Some embodiments comprise storing the plurality of applications and/or information associated with the plurality of applications in a memory, wherein the memory comprises at least one of a memory coupled to the BOP at the sea bed, a memory coupled to the offshore drilling rig in communication with the BOP, and a memory coupled to the onshore control station in communication with the offshore drilling rig and/or the BOP.

Some embodiments of the present methods for communicating in a BOP control system comprise identifying a plurality of applications associated with a BOP, wherein the plurality of applications at least one of control and monitor a plurality of functions associated with the BOP, allocating a time slot for information transfer to each of the plurality of applications, wherein an application transfers information to a bus during the time slot allocated to the application, and monitoring the transfer of information onto the bus to detect when no information is available on the bus and to identify the application that was allocated the time slot during which a lack of information was detected. Some embodiments comprise activating an emergency BOP control process upon detecting a lack of information on the bus. In some embodiments, the bus comprises a plurality of replicated channels, wherein an application transfers the same information onto each of the plurality of replicated channels during the time slot allocated to the application for information transfer. In some embodiments, the time slot during which an application may transfer data is periodic and repeats after a time period equal to the sum of all time slots.

Some embodiments comprise accessing information associated with a first application by reading information on the bus during the time period allocated to the first application for information transfer. In some embodiments, an application access the bus while executing at least one of a processor coupled to the BOP at the sea bed, a processor coupled to the offshore drilling rig in communication with the BOP, and a processor coupled to the onshore control station in communication with the offshore drilling rig and/or the BOP.

Some embodiments of the present methods for controlling a BOP function comprise receiving a first identifier associated with a first BOP, identifying a first model that specifies the structure of the first BOP and a plurality of controllable functions of the first BOP based on the received first identifier associated with the first BOP and actuating/controlling a first function of the first BOP in accordance with specifications provided in the identified first model for the first BOP. In some embodiments, identifying the first model comprises comparing the received first identifier associated with the first BOP to a database of BOP models, wherein each BOP model in the database of BOP models is associated with a unique identifier that can be compared to the received first identifier to identify the appropriate BOP model for the first BOP.

In some embodiments, the first BOP comprises at least one of a physical BOP model and a virtual BOP model. In some embodiments, the first BOP comprises a live running BOP, the first model comprises a real time model for the live running BOP, and the actuating/controlling of the first function of the first BOP happens in real time based on at least one of user input provided at a user interface and processing of parameters associated with the first BOP.

Some embodiments comprise outputting a display representative of the identified first model at a user interface, wherein the user interface comprises at least one of a user interface coupled to the first BOP at the sea bed, a user interface coupled to an offshore drilling rig in communication with the first BOP, and a user interface coupled to an onshore control station in communication with the offshore drilling rig and/or the first BOP, receiving an input at the user interface, and actuating/controlling the first function of the first BOP based on the received input.

Some embodiments comprise receiving parameters associated with the first BOP, processing the received parameters, wherein the received parameters may be processed with at least one of a processor coupled to the first BOP at the sea bad, a processor coupled to an offshore drilling rig in communication with the first BOP, and a processor coupled to an onshore control station in communication with the offshore drilling rig and/or the first BOP, and actuating/controlling the first function of the first BOP based on the processing of the received parameters.

Some embodiments comprise receiving a second identifier associated with a second BOP, identifying a second model that specifies the structure of the second BOP and a plurality of controllable functions of the second BOP based on the received second identifier associated with the second BOP, and selecting to control at least one of the first BOP and the second BOP, wherein actuating/controlling comprises actuating/controlling, based at least in part on the selection made, at least one of the first function of the first BOP in accordance with the specifications provided in the identified first model for the first BOP, and a second function of the second BOP in accordance with specifications provided in the identified second model for the second BOP.

Some embodiments of the present methods for autonomously controlling, monitoring, and analyzing a BOP comprise monitoring, by a processor, a plurality of parameters associated with a BOP located on the sea bed, wherein the processor is coupled to the BOP, analyzing, by the processor, the plurality of monitored parameters, detecting, by the processor, a well shut down event based, at least in part, on the analyzed plurality of monitored parameters, and actuating, by the processor, a hydraulic valve to send hydraulic fluid directly to at least one hydraulic device associated with the BOP upon detecting the well shut down event, wherein the at least one hydraulic device shuts down the well. In some embodiments, the at least one hydraulic device associated with the BOP comprises at least a BOP ram.

In some embodiments, the plurality of parameters associated with the BOP comprise at least one of a pressure and a temperature associated with a well coupled to the BOP. Some embodiments comprise coupling a plurality of sensors to the BOP, wherein the plurality of sensors are configured to sense variations associated with the plurality of parameters associated with the BOP and transmitting information from the plurality of sensors to the processor.

In some embodiments, the well shut down event comprises at least one of a user input provided by an operator located on an offshore drilling rig indicating that the well should be shut down, and a result of the analysis that indicates that the well should be shut down. In some embodiments, the BOP is disconnected and receives no communication from an offshore drilling rig and transmits no information to the offshore drilling rig.

Some embodiments of the present methods for logging information associated with the operation of a BOP to allow for behavioral simulation of the BOP comprise accessing a bus on which information associated with the operation of the BOP is transferred, recording the information on a bus that is associated with the operation of the BOP in a memory, wherein the memory comprises at least one of a memory coupled to the BOP at the sea bed, a memory coupled to the offshore drilling rig in communication with the BOP, and a memory coupled to the onshore control station in communication with the offshore drilling rig and/or the BOP, simulating the operation of the BOP with a behavioral model for the BOP, wherein the simulation is based, at least in part, on the processing of the information recorded in the memory, and outputting a visual representation of the simulation of the operation of the BOP at an interface, wherein the interface comprises at least one of an interface coupled to the BOP at the sea bed, an interface coupled to the offshore drilling rig in communication with the BOP, and an interface coupled to the onshore control station in communication with the offshore drilling rig and/or the BOP.

In some embodiments, the recording is in real time and the simulation is in real time such that an event occurring at the BOP while the BOP is in operation is observed at the interface in real time. In some embodiments, the simulation replicates an event that was observed on a live running operational BOP.

Some embodiments of the present methods for increasing the reliability, availability, and fault tolerance of a BOP comprise installing a BOP control operating system to at least one of control, monitor, and analyze the BOP, and adding at least one level of redundancy to a plurality of applications and/or components of the BOP control operating system. In some embodiments, the plurality of applications and/or components of the BOP control operating system that have at least one level of redundancy added comprise at least one of a bus located in at least one of a subsea location, an offshore and above-sea location, and an onshore location, a plurality of applications to at least one of control, monitor, and analyze BOP operations and BOP components, and a processing resource located at at least one of a subsea location, an offshore and above-sea location, and an onshore location.

In some embodiments, each of the plurality of applications and/or components of the BOP control operating system is located at at least one of the BOP at the sea bed, an offshore drilling rig in communication with the BOP, and an onshore control station in communication with the offshore drilling rig and/or the BOP.

In some embodiments, the BOP control operating system comprises at least one of a human machine interface application, an operating system application, a BOP control application, and a plurality of applications to at least one of control, monitor, and analyze BOP operations and BOP components.

Some embodiments of the present methods for high frequency distribution of power to a BOP control operating system comprise receiving/obtaining an alternating current (AC) power signal, increasing the frequency of the AC power signal and the voltage of the AC power signal to create a high frequency AC power signal, and transmitting the high frequency AC power signal to a BOP control operating system. In some embodiments, the AC power signal comprises a combined power and data signal. In some embodiments, the BOP control operating system comprises a BOP and a network of control/monitoring/analysis components/functions coupled to the BOP.

Some embodiments comprise rectifying the high frequency AC power signal to create a DC power signal and distributing the DC power signal to different components/functions of the BOP control operating system. In some embodiments, receiving/obtaining the AC power signal comprises receiving/obtaining at an offshore platform, increasing the frequency of the AC power signal and the voltage of the AC power signal comprises increasing the frequency of the AC power signal and the voltage of the AC power signal at the offshore platform, and rectifying the high frequency AC power signal comprises rectifying with the BOP control operating system.

Some embodiments of the present methods for distributing power and data to a network within a BOP control operating system comprise receiving a data signal, receiving a power signal, combining the data signal and the power signal into a combined power and data signal, and transmitting the combined power and data signal to a network within a BOP control operating system. In some embodiments, the network within the BOP control operating system comprises at least a BOP and a network of control/monitoring/analysis components/functions coupled to the BOP.

In some embodiments, combining the data signal and the power signal comprises inductively coupling the data signal and the power signal together to create an inductive combined power and data signal. In some embodiments, receiving the data signal and the power signal comprises receiving at an offshore platform, and combining the data signal and the power signal comprises combining at the offshore platform.

Some embodiments comprise separating the data signal from the power signal, wherein separating the data signal from the power signal comprises inductively decoupling the data signal from the power signal to create a separate data signal and a separate power signal. Some embodiments comprise distributing the separated data signal and the separated power signal to the network within the BOP control operating system.

The claims are not intended to include, and should not be interpreted to include, means-plus- or step-plus-function limitations, unless such a limitation is explicitly recited in a given claim using the phrase(s) “means for” or “step for,” respectively.

1-25. (canceled)

26. A method for controlling a blowout preventer (BOP), the method comprising:
identifying a plurality of controllers, each in communication with a BOP control network and configured to transmit information associated with the BOP;
placing each controller into communication with one or more processors;
assigning to each controller a respective time interval during which the controller can transmit information through the BOP control network; and
transmitting through the BOP control network, with a first controller, and during the respective time interval assigned to the first controller, information associated with the first controller.

27. (canceled)

28. The method of claim 26, where the respective time intervals are assigned to each controller such that no time interval respective to any one of the controllers in communication with a first set of one or more BOP components overlaps any other time interval respective to any one of the controllers in communication with a second set of one or more BOP components, the first set of BOP components different than the second set of BOP components.

29. (canceled)

30. The method of claim 26, comprising storing, in a memory associated with the first controller, at least a portion of the information associated with the first controller.

31. The method of claim 30, comprising accessing via the BOP control network, with a second controller, at least a portion of the information associated with the first controller stored in the memory.

32. The method of claim 26, comprising accessing via the BOP control network, with a second controller, at least a portion of the information associated with the first controller transmitted via the BOP control network.

33. (canceled)

34. (canceled)

35. The method of claim 32, where the accessing with the second controller occurs during the respective time interval assigned to the first controller.

36. The method of claim 26, where the identifying the plurality of controllers comprises scanning the BOP control network to locate controllers in communication with the BOP control network.

37. The method of claim 26, where the transmitting with the first controller only occurs during the respective time interval assigned to the first controller.

38-44. (canceled)

45. A method for controlling a blowout preventer (BOP), the method comprising:
identifying a plurality of controllers, each in communication with a BOP control network and configured to transmit information associated with the BOP;
placing each controller into communication with one or more processors;
assigning to each controller a respective time interval during which the controller can transmit information through the BOP control network; and
monitoring the BOP control network during each respective time interval for a transmission of information associated with the controller assigned the respective time interval.

46. The method of claim 45, comprising detecting a malfunction in a transmission of information associated with at least one controller during the respective time interval assigned to the at least one controller.

47. The method of claim 45, comprising detecting an absence of a transmission of information associated with at least one controller during the respective time interval assigned to the at least one controller.

48-61. (canceled)

62. A blowout preventer (BOP) control system comprising:
a signal coupler configured to receive a power signal and a data signal and couple the power signal and the data signal into a combined power and data signal; and
a subsea signal decoupler in electrical communication via one or more cables with the signal coupler and configured to receive the combined power and data signal and decouple the power signal and the data signal;
where the system is configured to provide at least one of power and data to one or more subsea controllers.

63. The system of claim 62, comprising an amplifier configured to increase the amplitude of at least one of: the power signal, the data signal, and the combined power and data signal.

64. The system of claim 62, comprising a frequency converter configured to increase the frequency of at least one of: the power signal, the data signal, and the combined power and data signal.

65. The system of any of claim 62, where the one or more cables comprises a plurality cables disposed in parallel between the signal coupler and the subsea signal decoupler.

66. The system of claim 62, where at least one of the one or more cables is inductively coupled to at least one of the signal coupler and the subsea signal decoupler.

67. (canceled)

68. The system of claim 62, comprising one or more subsea controllers, each in electrical communication with the subsea signal decoupler and configured to receive at least a portion of the power signal and at least a portion of the data signal.

69. (canceled)

70. (canceled)

71. The system of any of claim 62, where the signal coupler is configured to inductively couple the power signal and the data signal into the combined power and data signal.

72. The system of claim 62, where the subsea signal decoupler is configured to inductively decouple the power signal and the data signal.

73. The system of claim 62, comprising a subsea rectifier configured to produce a direct current (DC) signal from at least one of: the power signal, the data signal, and the combined power and data signal.

74-85. (canceled)
